(19) United States
(12) Patent Application Publication
(10) Pub. No.: US 2014/0012787 A1
(43) Pub. Date: Jan. 9, 2014

(54) SYSTEM AND METHOD FOR INFORMATION PROCESSING AND MOTOR CONTROL

(71) Applicant: Qin Zhang, Los Angeles, CA (US)

(72) Inventor: Qin Zhang, Los Angeles, CA (US)

(21) Appl. No.: 14/018,419

(22) Filed: Sep. 5, 2013

Related U.S. Application Data
(63) Continuation of application No. 12/452,249, filed on Dec. 18, 2009.

(51) Int. Cl. G06N 5/02; G06N 99/00

(52) U.S. Cl. CPC G06N 5/02; G06N 99/005; Y10S 901/50; Y10S 901/46
USPC 706/12; 706/60; 706/46; 901/50; 901/46

(57) ABSTRACT

The present invention relates to a system and method for information process and motor control using artificially constructed apparatus. More specially, the present invention provides a system and method that can process nature language and other informational input including visual, audio and other sensory inputs and respond intelligently.

The present application is a continuation of utility application entitled “System and Method for Information Processing and Motor Control” with application Ser. No. 12/452,249, filed on Dec. 18, 2009.

### FIELD OF INVENTION

The present invention relates to a system and method for information processing and motor control using artificially constructed apparatus. More specially, the present invention provides a system and method that can process nature language and other informational input including visual, audio signals and respond intelligently, including providing output and/or control movements of the system components.

### BACKGROUND OF THE INVENTION

The failure of traditional mathematical method for establishing artificial intelligence is not accidental, because pure logical or mathematical operations are not content specific, thus properties of the elements in the operations are not taken into account in this operations. In mathematic operation, entities possesses equal amounts of properties having numeric values, while in languages that reflect general structure of the world, entities have various types of properties with or without numeric values. The neural network seems to be able avoid this shortcoming by extensive use of inductive operations that in essence taking into account of the properties of the elements without directly referring to them individually. But the problem of the neural network is determined by the principle of the inductive process, that the outcomes are only possibilities, not with certainties. It seems that the systems that do not directly address the complicity of the property features of the elements are not capable of producing adequate results. In dealing with the complicated properties of the elements, it seems that languages are the most adequate representation. As it seems that establishing a new and equivalent symbolic system will provide no additional results, there seems to be no reason to abandon the existing languages as the symbolic systems of the human knowledge system and to produce a new one. Therefore, the knowledge system of the present invention is basically constructed based on the human languages. As this application is written in English, thus English is used as the symbolic system of the knowledge system of the present invention.

It is the assumption of the present invention that human knowledge system is a presentation of the impressions on human mind of the outer world. The establishment of the human knowledge system is dependant on the human capabilities, and the validity of the human knowledge system is generally based on the usefulness of this system, i.e., enhancing the predictability of the future impacts and providing assurances for desired results. The establishment of the human knowledge system started with division or definition of the objects (particular). But definitions of the objects are based on specific combination of various property values. Therefore, properties (universal) must first be established, and yet properties do not exist independent of the objects. Thus, we can see, that establishment of the human knowledge system is a circular process, each item is depend on other items, there is no fundamental items that other items will be built on (This is why the attempt to establish a universal language will always fail).

One of the problems with human knowledge system is that many elements (or concepts) do not have definite meaning within acceptable ambiguity. In addition, make links between elements are arbitrary, especially among elements without definite meanings, different people will have different definitions and establish different links for the elements, and this is what we call subjective. Therefore, human knowledge system is not one defined system, there can be as many as the numbers of the human beings as the human knowledge system. A significant portion of the system can be mostly alike, while other potion can divert largely. Depending on the purpose of establishing the knowledge system, the embodiment of the present invention could be more or less universal, or highly specific. The differences are at the inclusion of elements, the extents of the definitions of the elements and the links between the elements, and the generally applied rules in the execution system (usually related to higher level thinking processes, learning capacity, prediction, assumptions, and creations, which is the volatile part of the thinking process).

### SUMMARY OF THE INVENTION

In one preferred embodiment of the present invention, the method of the information process and motor control system (herein after “robot system”) comprises the steps of:

establishing a knowledge structure including a file organizing mechanism, and more than one element files, wherein the element files including identifying information and knowledge information;
establishing a process structure comprising a process file organizing mechanism, and at least one process file;
establishing a world knowledge base;
establishing an action sequence structure;
establishing a document structure comprising document entry files, document addresses, and document contents, and a document organizing mechanism;
establishing an executing system comprising an internal control mechanism and an inputting mode, a reading mode, a thinking mode, a writing mode, a memorizing mode, an outputting mode, an inquiry mode, verification mode, and a system update mode;
wherein the internal control mechanism further comprises internal control rules and structure rules, wherein the internal control rules include basic rules, target rules, value rules, determinative rules, responsive rules, and control rules;
establishing a system log;
running the executing system wherein the internal control mechanism can operate constantly, wherein the thinking mode, inquiry mode, memorizing mode, verification mode, and a system update mode can be activated according to the internal control rules of the internal control mechanism not triggered by an input;
if input information is to be received from an inputting device of a sensing and information gathering system, the internal control mechanism will operate inputting mode according to the internal control rules, wherein the input information will be converted to format conformed with the format requirement by the executing system according to the inputting rules, wherein information other than language may be converted to language information, or information other than language may be pre-processed by the information processing tools to prepare for further processing in the reading mode;
once input information is received by the executing system, the internal control mechanism will activate reading mode according to the internal control rules, wherein according to the reading rules, the input will be disseminated into elements and element files of the knowledge structure with corresponding elements matched with the input elements will be located and loaded into the executing system (or areas easily accessible by executing system) according to the file organizing mechanism of the knowledge structure;
if it is determined a specific task is called for, the internal control mechanism will activate the thinking mode, wherein according to the thinking rules designated by the internal control mechanism, the thinking mode can establish new direct links between the existing elements of the knowledge structure that match with the elements of the input information according to the input information;
wherein the new direct link between the first existing element and the second existing element can be saved to the element file of the first existing element and the element file of the second existing element by the memorizing mode according to the memorizing rule, wherein the linking process for linking the first existing element with the second existing element can be saved as a process file to a process structure by the memorizing mode according to the memorizing rule, wherein information including the new direct link between the first existing element and the second existing element can be written to a display device by the writing mode according to the writing rules and the structure rules of the internal control mechanism, wherein the new direct link between the first existing element and the second existing element can be converted to information other than language and outputted as control signal to output device by the outputting mode according to the outputting rule;
wherein the internal control mechanism can operate inquiry mode according to the internal control rules, wherein the inquiries can be sent to display device or output device to inquire information, or document structure, wherein the input information responding to the inquiries will be processed by inputting mode, reading mode, and thinking mode, and memorizing mode to establish new direct links between the existing elements, new direct links between new elements and existing elements of the knowledge structure, and new element files;
if new links and/or new element files and/or new process files are established, the internal control mechanism can operate the verification mode to verify new direct links and the new linking processes; the internal control mechanism can also operate the system update mode to update the internal control rules, the structure rules, and the process files in the process structure, wherein the system operator's participations are often needed.

In one preferred embodiment of the present invention, the robot system comprises: a body, a sensing and information gathering system, an information inquiry system, an information output system, a knowledge structure, a process structure, a world knowledge base, an action sequence structure, a document structure, an executing system, a system log, and actuation system.

In one preferred embodiment of the present invention, a computer hardware system is used as part of the embodiment of the present invention that includes at least one computer, having at least a processing unit, a memory, an I/O interface, an I/O device, and a system bus that interconnects various system components to the processing unit. The memory includes at least one read only memory (ROM) and one random access memory (RAM). A basic I/O interface, containing the basic routines that help to transfer information between elements within the computer, such as during start-up, is stored in ROM. The system bus comprises bus structures such as address buses, data buses, and control buses.

In this embodiment, the sensing and information gathering system includes I/O devices that provide input to the computer, and the information inquiry system, the information output system, and the actuation system are I/O devices that the computer provides control. The body can be actuated by the actuation system. The knowledge structure, the process structure, the world knowledge base, the action sequence structure, the document structure, the executing system, and the system log are mostly software systems that are contained in the memory. The operation of the executing system is mostly realized through the operation of at least one processing unit.

According to the present invention, the human knowledge system basically is a system with multiple, multidimensional links between various elements, and the function of the human languages, and more specifically sentences of the human languages is to establish and express links between various elements. By treating sentences as links between elements, the variation and complexity of the sentence structures is dissolved.

The knowledge structure comprises numerous element files and a file organizing mechanism. Each element file contains information identifying and distinguishing the element and knowledge indicating direct connections of this element with other elements. The identifying information is about whether the element is a word, a phrase, a symbol, or a graphic, etc., and for a word, what language is the word, and whether the word is a noun, a verb, a pronoun, etc. The connection information is about whether the meaning of the word is general, specific, or interchangeable with other words, the way the element is supposed to be used in sentences, the conditions and results related with the element, the attributes of the element, and other information indicating how this element is related to other elements. Further, information in the element files will tell executing system to how to act in respond to the information. Preferably, each element file comprises an identification file, and a link file. The file organizing mechanism provides ways for the element files to be easily located by the executing system. The file name of the element file could be the name of the element. The element files could be arranged according to the alphabetical order of the elements, and the element files could be located alphabetically by the executing system according to the organizing mechanism.

The executing system can take information, read information, think about the information, write answers, output answers and give commands to activate other devices, memorize changes to the element files and new processes, verify changes and new processes, and update system commands or setup. The executing system comprises internal control mechanism contains internal control rules that are instructions so that not only it will be in action in respond to the input, but also will be in action according to the internal setup or instructions of the executing system. The internal control mechanism also includes structure rules containing sentence structure information for analyzing and reconstruct sentences. The structure rules can also contain logic structure information for making decisions in linking processes.

The executing system can take input and convert it into readable format, then read the information, i.e., each element of the input will be identified by searching and locating the element file that matches this element. The element files will be loaded to a location easily accessible by the executing system. Then the executing system will start thinking mode by looking into the element files and find out whether the element is a noun, a verb, a pronoun, a symbol, etc. This information of the words in the sentence will be matched with standard sentence structures according to the structure rules in the executing system. The executing system may contain special internal control rules that correspond to special inputs as commands for special action routines that designate the sequences of the internal control mechanism. If no specific action routine is setup, any match of the specific sentence structure will trigger a preset action routine. For a statement sentence, new links of the words will be established by the statement. For a question sentence, a sequence of actions will be taken to perform the task to find answers for the question. For a command sentence, actions will be taken to follow the command. Actions taken by the executing system will require further reading of the element files in the sentences. The sequence of actions that lead to successfully perform the task will be saved as a process file, identified by initial input and the task request. The process files belong to the process structure, acted as the rule base for the executing system. Preferably, any actions taken by the executing system will be simultaneously saved in the system log, identified by critical elements, time of actions, etc. Preferably, the executing system of the present invention will also be able to imitate human logic process such as generalization, deduction, etc. to make new links and create new process files according to existing links and process files. These actions should be directed by commands provided by the executing system, rather than external inputs.

The system of the present invention is capable of making inquiries to system operator and/or database library, and/or internet resources about new elements, conditions and links. The executing system will command to make new links or make new inquiries. The executing system can also verify the established links and processes by making inquiries to confirm the links and process. Therefore, the system of the present invention will not only respond to the inputting commands, but also generating its own commands according to the executing system set up, knowledge structure and process structure, and sometimes system log. The executing system of the present invention should be able to accept new commands and process routines from input convert them into internal set up.

### BRIEF DESCRIPTION OF THE DRAWINGS

The above and further features and advantages of the present invention may be appreciated from the detailed description of preferred embodiments with reference to the accompanying drawings, in which:

FIG. 1 is a schematic illustration of one preferred embodiment of the method of the present invention;

FIG. 2a is a schematic illustration of one preferred embodiment of the implication of the system of the present invention;

FIG. 2b is a schematic illustration of one preferred embodiment of the computer hardware implication of the system of the present invention;

FIG. 3 is a schematic illustration of one preferred embodiment of the knowledge structure of the system of the present invention;

FIG. 4 is an exemplary illustration of a word tree in a first link information file of an element file in the knowledge structure of the system of the present invention;

FIG. 5 is a schematic illustration of one preferred embodiment of the executing system of the system of the present invention;

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

A close look of the human “rule making” process indicates that most of the rules are simply direct or indirect links between the given conditions and the end results. Any task is provided with a given condition, and demands a desirable end result. The human learning process is to establish the link between given condition and end result by “try and error”, direct rule making, reference, induction, and deduction, etc. The sophisticated thinking process usually involves a skilled combination of various rules to establish the connection between the given condition and the end result.

Therefore, the key to accomplish various tasks is to obtain as many useful rules as possible and to successfully combine the rules. The purpose of the present invention is to provide a method and system to obtain useful rules and successfully combine the rules.

A basic consideration of the present invention is that in general the human knowledge system is not a liner system as in basic mathematic system. The complication of the human thinking process derived at least partially from the existence of multiple elements where the relationship between them cannot be quantified in simple dimensions. Therefore, one aspect of the present invention is to establish a knowledge structure that can best capture the essence of the human knowledge system yet provide fundamental basis for workable rule making. The goal is to find fundamental relationships between each element of the knowledge structure so that links between some elements of the knowledge structure can be applied to other elements. This goal is accomplished with the helps of generalization, among others. In studying the human knowledge system as manifested in various languages, it is apparent that some elements (words or phrases) are more general in meaning. Therefore, some elements (words or phrases) can be replaced by other elements (words or phrases) in sentences. This is one of the bases for knowledge structure of the thinking system of the present invention.

Since the links between knowledge elements are multi-dimensional, the knowledge structure is established to reflect this characteristic. Every element of the knowledge structure is provided with an element file containing all the information of the element for establishing links. Basically, the information of the element file is information related to links of this element with multiple other elements. Therefore, a link between two elements will be reflected in both of the element files.

The executing system of the present invention contains and executes the commands and action procedures of the system. The executing system of the present invention will respond to the link information of the element files of the knowledge structure and take action according to the link information. One special feature of the executing system that reflects the novelty of the present invention is the active acquisition of knowledge. It will also be able to establish and expend the links between elements. It will also be able to create rules according to existing information, and save these rules in process files. New information will be used to create new links and rules, and the executing process will be saved simultaneously in a system log as log files. These processes are similar to the human memorizing processes. Basically, the system of the present invention not just responds to commands and inputs as in existing AI system, it will also generate commands and acquire inputs. The process is dynamic, self-driven, as in human thinking process.

The difference between the present invention and the existing system and method is that the present invention intends to establish multiple links between any elements of the knowledge structure. With the knowledge structure contains these links, the relative relations within these elements are established. Therefore, any given elements will lead to other elements by invoking these links, so the system of the present invention will be able to understand the meaning of each elements and in turn the meaning of each sentence and so on.

A word or phrase can be defined by meaning and function. To give a meaning to a word, two steps are needed. First, divide the words into groups; second, establish relationship of the words within the group. The relationships of the words within the group includes nonrestricted unconditional equal (exchangeable), restricted unconditional equal, nonrestricted conditional equal, restricted conditional equal, one way equal, one way inclusive, partially common inclusive, word of opposite meanings, possessive, etc. Restricted equal means the word has different meanings, and in one meaning the word will be equal to another word. To define the word by function is to establish relationships between words in different groups. This is usually indicated by functions of the word in the sentences, and is defined by the structure of the sentence. A phrase usually equals in meaning and function with a word. It can be treated as a word in most situations.

A preferred embodiment of the present invention divides words into noun, verb, pronounce, adjective, etc. Every word has an element file with identification file or field indicating which group this word belongs to (there might be more that one group indication, with related condition and need verification). The element file of a word also includes link fields or link files contain links with other words, symbols, graphics, etc. including restrictions, conditions, and other related parameters. For the link information related to the function of the word, the element file will include information regarding how the word interact with other words and is situated in sentences, and what this word will respond to or will trigger the action from. The element file can also contain information about the words that cannot be associated together as an exemption of the general rule. The element file can also contain information about grammar changes of one word as a response to another word. The element file of the word can include information fields or information files indicating various attributes of the word.

Related to the function definition, the sentence structure in the structure rules of the executing system further established the relationship between words. Various possible sentence structures can be provided as alternative default setting of the sentence. This sentence structure information can be used for writing a sentence, getting information from inputted sentences, etc. In general, sentences provide link information between words under certain conditions.

The first important step of establishing knowledge structure is to input information about words, phrase, symbols etc. in element file format either by human input or system automatic process. In general, the initial knowledge structure will be established by human operators. As the system of the present invention become more complete and sophisticated, the knowledge structure can be expended with little human assistance, most likely just to verify the result by humans. When element files for most of the common words and phrases are established, a new element file can be established by dictionary definition, then the executing system of the present invention can expend the element file to fill in most of the information in this element file according to element files for the words in the definition. Attribute information related to the new element can be obtained by the executing system by initiating the information inquiry process and followed with subsequent processes.

For example, establishing the knowledge structure can start with establishing element files for commonly used words. The basic idea of the knowledge structure is to establish connections between words, phrases or symbols. As part of the structure, words are divided into different groups, such as verb, noun, pronoun, adjective, adverb, etc. In a preferred embodiment, each word, phrase or symbol has an element file comprises identification, attribute and link information related to the word, phrase or symbol.

An element file for a specific word may include information indicating whether it is a word, a phrase, or a symbol; what language it is; whether it is a verb, noun, or pronoun, etc.; the class and form of the word; information indicating other words that are more general in meaning, less general in meaning, or similar in meaning; sentence format related to the word; and information related to causes and result of the occurrence related to the word; attributes of the word; and other information. Preferably, the link between two words is indicated in the both element file for each word.

In this application, English is the language for the knowledge system. The knowledge system for other language will be similar with some variations due to differences in grammars. In studying English, we can find that nouns may name a person, a thing, a place, time, a quality, or an idea, and it can be defined by the relationship with other nouns. For example, a specific city can be defined by the state and country, the distances with other cities, geographic location and dimensions, its population, weather, economy, attractions, and so on. The content of this information can be in plain text, or in predefined fields.

In general, words may represent entities, actions, status, or other states of existence. Nouns are used for representing entities, verbs are used for representing actions of entities, or relationships between entities, or status of the entities.

The nouns can be divided into classes including common nouns, proper nouns, collective nouns, count nouns, mass nouns, concrete nouns, abstract nouns. The common nouns refer to general classes, ex. book, government, music. Proper nouns name specific people or places, ex. Susan, Athens, Candlestick Park. Collective nouns name groups, ex. team, class, jury, family. Count nouns name things that can be counted, ex. ounce, camera, pencil, person, cat. Mass nouns name things that are not normally counted, ex. jewelry, milk, music, information. Concrete nouns name tangible things, ex. ink, porch, bird. Abstract nouns name ideas or qualities, ex. quality, greed, capitalism.

The common nouns are basically names for entities with similar properties, or we can say a common noun is a name for any member of a class. When need arises that common noun is used to present a particular object, additional descriptions usually will be provided. For example, “a table” refers to any member that belongs to the class of “table”, while “the table that I bought yesterday” refers to a particular table that is described by the relationship to me and my action. Thus in establishing links of common nouns, especially when indicate the functions of the common nouns, special care needs to be taken so that the link information is not over broad. In understanding the differences between common nouns and cases when common nouns are used to refer to particular object, the words (article) “a”, “the” can often present indications.

The proper nouns are intended to present particular entities. Therefore, element files of the proper nouns may have many detail information. However, same word or words may be used for different entities, thus often additional information may be needed to make distinctions between different entities with same names. For example, there are many women who are named “Susan”, and some of them even have the same last name. In real life, social security numbers and driver license numbers are often used for official identification. For daily life, descriptive words are often used to further define the person in question. For example, “tall Susan” or “blonde Susan” can be used to distinguish from other people in question. However, sometimes in everyday life, the identification can only be inferred by the context of the conversation. For example, if someone said “Susan went to Hawaii to see her parents” and you happen to know which Susan's parents live in Hawaii, you know who is being referred to. Strictly speaking, only a few proper nouns truly have unique representation of an object, such as, “earth”, “sun”. In a preferred embodiment of the present invention, element files of the proper nouns include additional identification information (such as social security number) to assure the element file represent the specific entity.

The collective nouns may have characteristics that can be transfer to the components of the collection, but the basic characteristics are not generally transferable as the common nouns. For example, the sentence “Jury reached a verdict” does not mean that “Susan reached a verdict” even if Susan is a member of the Jury, as the act of reaching a verdict can only be performed collectively (in a Jury trial), not by the act of the individuals. This collective feature of the collective nouns usually only related to the purpose of the collective body, but the distinction between the collective nouns and common nouns should be noticed.

The count nouns are one of the features that directly related to the structure (or grammar) of the English language, as in Chinese language there is no such category. When a noun is a count noun, the article “a” can be used prior to the count noun to indicate single object, and “s” usually will be added to the end of the count noun (with a few exception) when multiple counts of the objects are intended.

The mass nouns are about as the counterpart of the count nouns as one of the features that directly related to the structure (or grammar) of the English language. There is no single-multiple change of form distinction, as the existences represented by the mass nouns cannot be counted. But the existences represented by the mass nouns may be counted in directly. For example, in “a glass of milk”, the quantity of the milk is counted by the container of it. Here, the information about the type of nouns are useful for constructing sentences with the correct grammar.

The concrete nouns generally refer to objects in the outer world, with other references such as images, sounds, touches, etc. With the outer existences as the references, most knowledge (links between the concrete nouns with others, and with other words) is generally in agreement. Thus, the links established directly related to the concrete nouns are usually objective links (with relatively high certainty).

The abstract nouns generally refer to concepts developed in the human minds based on the relationship with the words such as concrete nouns. As human minds are basically independent of each other, the concepts that developed in the human minds are less in agreement, we often call the links related to the abstract nouns as subject links (depending on the belief system).

Nouns have forms in subjective and objective case, possessive case, and plural. The subjective and objective case is the general form of a noun. Possessive case is shown by the use of the apostrophe or by a “of” construction. The awareness of the forms can help the understanding of the meanings of the sentences, and information related to forms of nouns will help build sentences with correct grammar.

The element files for verbs may contain different information than that of nouns. Verbs express an action (bring, change, grow), an occurrence (become, happen), or a state of being (be, seem). Verbs can be divided into classes as transitive, intransitive, linking verbs, and auxiliary verbs.

A verb is intransitive when the context does not require an object to complete its meaning. Most verbs are intransitive. A verb is transitive when the context requires an object to complete its meaning. Both intransitive verbs and transitive verbs usually represent some forms of actions, and actions often bring changes of the status of the entities or relationships between entities.

The linking verb links subject and object. Linking verbs indicate a state of being or a condition. Depending on the natures of the subjects and objects, linking verbs may present different relationship between the subjects and the objects. When the subject is a name for an entity, and the object is a name for another entity, it usually indicates that the subject belongs to the object (or, in another word, the subject is a member of the object class.) For example, the sentence “Socrates is a man” indicates that “Socrates” is an entity that belongs to a class called “man”. When the subject is a name for an entity, and object is a name for a property, it usually indicates that the subject possesses a property that the word of the object presented the value. Here, the sentences maybe are in short forms, such that the sentence “E is A” is actually “The property (B) of E is A”. For example, when we say “The apple is red”, we actually mean that “The color (the property of an object) of the apple (object) is red (value of the property)”. When the subject is a word for a property or a value of a property, and the object is a name for a property, it usually indicates that the subject belongs to the object (or, in another word, the subject is a member of the object class.), or the subject is a value of the object. For example, the sentence “Red is a color” indicates that “Red” is a value of the property (of an object) called “color”. Knowledge of the classes of the verbs can be useful in establishing new connections between words using information in the existing element files of the words.

Auxiliary verbs are forms of the verbs be, do, have, and others. Auxiliary verbs combine with main verbs to make verb phrases. The verbs can, could, may, might, must, shall, should, will, and would are modal auxiliary verbs. Modal auxiliaries work in concert with the simple form of main verbs to communicate a meaning of ability, permission, obligation, advisability, necessity, or possibility. The auxiliary verbs or the auxiliary verb phrases have more than one function. In one situation, they can be used to form different sentence structures such as question sentences, etc. In another situation, the use of the auxiliary verbs basically assigned a belief value to the conditions or links established by the combined verb phrases.

All verbs except “be” have five basic forms. The first three forms—simple, past tense, and past participle—are the verb's principal parts. The simple form is the form when the verb's action occurs in the present and the subject is a plural noun or the pronoun I, we, you, or they. The past-tense form indicates that the verb's action occurred in the past. If it is a regular verb, it formed by adding -d or -ed to the infinitive. For some irregular verbs, the past-tense forms are not formed by regular way. The past participle in regular verbs uses the same form as the past tense. In irregular verbs, the forms for the past tense and the past participle usually differ. A past participle can combine with an auxiliary verb in a verb phrase. Past participles combine with auxiliary verbs to form perfect tenses and passive-voice verbs. Used alone, a past participle functions as an adjective. Verbs also have a present participle. It is formed by adding -ing to the simple form. To function as a verb, the present participle must combine with an auxiliary verb in a verb phrase. Used alone, present particles function as adjectives or nouns. When a present participle functions as a noun, it is called a gerund. The -s form of a verb occurs in the third-person singular in the present tense. The -s ending is added to a verb's simple form. The verbs “be” and “have” are irregular verbs. For the third-person singular, present tense, “be” uses “is” and “have” uses “has”. The conditions and meanings and related various forms can be provided in element file for each verb respectively, and corresponding to the structure rules of the executing system, so that the executing system of the present invention can better understanding the meaning of the sentences after reading the element files for the verbs, and construct sentences with correct grammar.

Verbs use tense to express time. The three simple tenses divide time into present, past and future. Three perfect tenses also divided into present, past and future. The three simple tense and the three perfect tenses also have progressive forms. These forms show an ongoing or a continuing dimension to whatever the verb describes. The awareness of the tenses of the verbs can help the understanding of the meanings of the sentences as related to time sequences, and information related to tenses of verbs will help build sentences with correct grammar.

Mood refers to the ability of verbs to convey a writer's attitude toward a statement. The indicative mood is used for statements about real things, or highly likely ones, and for questions about fact. The imperative mood expresses commands and direct requests. The subjunctive mood expresses conditions including wishes, recommendations, indirect requests, and speculations. The mood could relate to belief values, which may trigger the value rules of the executing system to what to do or not to do, and it can also be an indication of the task input (as command sentence). The detection of mood may be made by using structure rules of the executing system, and information in the element files of some key words.

Voice refers to verb's ability to show whether a subject acts or receives the action named by the verb. English has two voices: active and passive. In the active voice, the subject performs the action. In the passive voice, the subject is acted upon, and the person or thing doing the acting often appears as the object of the preposition by. Verbs in the passive voice add forms of “be” and “have”, as well as “will”, as auxiliaries to the past participle of the main verb. The importance of the voice is only mostly in form, not much in substance, as in either active or passive voice, the sentence will establish the same link between the subject and object (sometime, it may indicate the difference in mood, but other than this, the link is the same). Correlation between the active and passive voice and construct the correct sentences can accomplished by the executing system of the present invention using structure rules and information in the element files of the words in the sentences.

Most pronouns substitute for nouns and function in sentences as nouns do. Pronouns fall into several classes depending on their forms or functions. Personal pronouns refer to a specific individual or to individuals. They are I, you, he, she, it, we, and they. Since nouns or noun phrases usually perform the function of identifying the specific entities (such as the case when the nouns are proper nouns, when pronouns are used substituting the nouns, special attention should be paid to maintain the identification clarity.

Indefinite pronouns, such as “everybody” and “some”, do not substitute for any specific nouns, though they function as nouns. The indefinite pronouns are often used in general proposition, or the “prepositional function” (as indicated in Bertrand Russell's theory of description). However, the common use of indefinite pronouns may be more casual, thus the meaning of the proposition should be carefully construed, cannot always be taken by the face value. For example, when a car salesperson say “Everybody is buying imported car now”, it cannot be construed that all of the people are imported cars now, or nobody is buying domestic cars now, but that many people are buying imported car now. The common inaccurate usage of the words or the ambiguous definitions of the words may present problems when the statements are used to draw further conclusion or making predictions. However, the general proposition sentences can be important knowledge if it is generally true, or at least under some defined condition. For example, a person says that “Everybody in our office has an imported car”, and we know that Susan works in this office and she has only one car, we can predict that Susan has an imported car (assuming we believe the statement is true).

Demonstrative pronouns, including this, that, and such, identify or point to nouns. The demonstrative pronouns often have circumstantial context that may have connections and indications outside of the scope of pure language operation. For example, in ordinary use, the sentence “This is Susan” usually is uttered by a person in the presence of “Susan” to another person (or persons) also present. Thus, through presence and gesture, knowledge can be transferred to the person (or persons) at the sight, while simple operation of the language alone would not convey the same amount of information. Therefore, the robot system of the present invention should take the demonstrative pronouns such as “this”, “that”, etc. (in conversational situation) as a signal for additional information intake operation (sometimes, personal pronouns should also have similar effect).

The relative pronouns who, which, and that relate groups of words to nouns or other pronouns. Intensive and reflexive pronouns have different functions but the same form: a personal pronoun plus -self. Intensive pronouns emphasize a noun or other pronoun. Reflexive pronouns indicate that the sentence subject also receives the action of the verb. Finally, interrogative pronouns, including who, which, and what, introduce questions. These pronouns are generally functional that often relate to the structure rules of the executing system of the present invention

The personal pronouns “I, he, she, we, and they” and the relative pronoun “who” change form depending on their function in the sentence. These requirements can be indicated in the structure rules of the executing system as well as the respective element files for these pronouns.

Pronouns have forms of subjective, objective, possessive. Subjective form is used when a pronoun is the subject of sentence, the subject of a clause, the complement of a subject, or an appositive identifying a subject. The objective form is used when a pronoun is the direct or indirect object of a verb or verbal, the object of a preposition, the subject of an infinitive, or an appositive identifying an object. The possessive form of a pronoun is used before nouns and gerunds. The possessive forms mine, ours, yours, his, hers, and theirs may be used without a following noun, in the position of a noun. These requirements can be indicated in the structure rules of the executing system as well as the respective element files for these pronouns.

Adjectives describe or modify nouns and pronouns, or word groups used as nouns, and can be divided into classes. Adjectives often name the values (or namely, quality) of the properties of the entities. The values of the properties are often indicated in the matters of degrees, thus the adjectives are often defined in relativity. Most of the time, the adjectives are used as indication of the subjective values of the properties.

Descriptive adjectives name some quality of the nouns. Limiting adjectives narrow the scope of a noun. They include possessives, words that show number, demonstrative adjectives, interrogative adjectives, and numbers. Proper adjectives are derived from proper nouns. Attributive adjectives appear next to the nouns they modify. Predicate adjectives are connected to their nouns by linking verbs. It can be divided into three forms distinguished by degree: a positive degree, such as good, green, angry, badly, quickly, angrily; the comparative form, such as better, greener, angrier, worse, more quickly, more angrily; the superlative form, such as best, greenest, angriest, worst, most quickly, most angrily. These requirements can be indicated in the structure rules of the executing system as well as the respective element files for these pronouns.

Adverbs describe the actions of verbs and also modify adjective, other adverbs, and whole groups of words, or sentences. Adverbs can be divided into classes of modifiers of verbs, adjectives and other adverbs; sentence modifiers; conjunctive adverbs. Adverbs also have three forms: positive, comparative, and superlative. Like adjectives that indicate the properties of the nouns, adverbs usually indicate the properties (or conditions) of the verbs, adjectives, adverbs, etc. that they modified, often by descriptions in the matters of degrees.

Articles usually are used to define nouns. The indefinite article, “a”, does not specifically define the noun. The definite article, “the”, define the noun. In the sentences, “a” is often used with common noun, while “the” is either used with proper noun, or a common noun that is specifically defined by other noun, adjective, phrase, or clause, or the combination of the them (or used in context that the noun has been mentioned before). If “a” is used with a common noun as the subject of a sentence, the sentence is mostly a general proposition, thus could contain significant amount of information (as many links can be established based on this statement). If “the” is used with a proper noun, or common noun that is specifically defined by other noun, adjective, phrase, or clause, or the combination of them as the subject of a sentence (or used in context that the noun has been mentioned before), the sentence is usually a definition for a particular entity or concept, or further description of the particular entity or concept.

Prepositions function with other words in prepositional phrases, which often describe relationship in time or space. The use of preposition may be context dependent, thus rules indicating the special use should be included in the element file of the preposition. Prepositional phrases usually function as adjectives or as adverbs, occasionally as nouns. Many prepositional phrases may have specific meanings that are different from their components, thus element files can be established for these prepositional phrases. The phrase must be attached to another group of words containing both a subject and a predicate. A prepositional phrase that introduces a sentence is set off with punctuation, usually a comma, unless it is short. A prepositional phrase that interrupts or concludes a sentence is not set off with punctuation when it restricts the meaning of the word or words it modifies. When an interrupting or concluding prepositional phrase does not restrict meaning, but merely adds information to the sentence, then it is set off with punctuation, usually a comma or commas. Prepositional phrases often provide conditions of the links between words, such as time, place, and manner, etc. Rules as to the locations and restrictions of the prepositional phrases in the sentences can be set forth by the structure rules of the executing system, and in the related element files.

The verbals are special verb forms such as participles, gerunds, infinitives, that can function as nouns or as modifiers. Any verbal must combine with a helping verb to serve as the predicate of a sentence. The present participle consists of the dictionary form of the verb plus the ending -ing. The past participle of the most verbs consists of the dictionary form plus -d or -ed. Some common verbs have an irregular past participle. Both present and past particles function as adjectives to modify nouns and pronouns. Gerund is the name given to the -ing form of the verb when it serves as a noun. Present participles and gerunds can be distinguished only by their function in a sentence. If the -ing form functions as an adjective, it is a present participle. If the -ing form functions as a noun, it is a gerund. The infinitive is the to form of the verb, the dictionary form preceded by the infinitive marker to. Infinitives may function as nouns, adjectives, or adverbs.

Participles, gerunds, and infinitives—like other forms of verbs—may take subjects, objects, or complements, and they may be modified by adverbs. The verbal and all the words immediately related to it make up a verbal phrase. With verbal phrases, we can create concise sentences packed with information. Like participles, participial phrases always serve as adjectives, modifying nouns or pronouns. Gerund phrases, like gerunds, always serve as nouns. Infinitive phrases may serve as nouns, adjectives, or adverbs. When an infinitive of infinitive phrase serves as a noun after verbs such as hear, let, help, make, see, and watch, the infinitive marker to is omitted (these information should be reflected in the element files of the these words). A verbal or verbal phrase serving as a modifier is almost always set off with a comma when it introduces a sentence. A modifying verbal or verbal phrase that interrupts or concludes a sentence is not set off with punctuation when it restricts the meaning of the word or words it modifies. When an interrupting or concluding verbal modifier does not restrict meaning, but merely adds information to the sentence, it is set off with punctuation, usually a comma or commas. Rules as to the locations and restrictions of the verbals and verbal phrases in the sentences can be set forth by the structure rules of the executing system, and in the related element files.

An appositive is a word or word group that renames the word or word group before it. The most common appositives are nouns that rename other nouns. All appositives can replace the words they refer to. Appositives are often introduced by words and phrases such as or, that is, such as, for example, and in other words. Although most appositives are nouns that rename other nouns, they may also be and rename other parts of the speech. Noun appositives are economical alternatives to adjectives to adjective clauses containing a form of “be’. Rules as to the locations and restrictions of the appositives and appositive phrases in the sentences can be set forth by the structure rules of the executing system, and in the related element files such as element files of the words or phrases that are often used as appositives.

Compounded words, phrases, and clauses are closely related and parallel in importance. The coordinating conjunctions and, but, nor, and nor always connect words or word groups of the same kind

The conjunctions for and so can connect words, phrases, or subordinate clauses. For may also function as a preposition. When it functions as a conjunction, it indicates cause. So indicates result. The word yet often functions as an adverb, but it can also function as a coordinating conjunction. Like but, it indicates contrast. The conjunction words usually have specific functions in the phrases or sentences, and they are basically function words with limited substantive meanings. Functional words could be operative words that have structural significance in the sentences. Thus, conjunction words may relate to specific structure rules, and can be designated by the structure rules.

Some conjunctions pair up with other words to form correlative conjunctions. Like prepositional phrases that have specific meanings that are different from their components, element files can be established for these conjunction phrases as well. Conjunction adverb relates only main clauses, not words, phrases, or subordinate clauses. Conjunction adverbs describe the relation of the ideas in two clauses.

A clause is any group of words that contains both a subject and a predicate. There are two kinds of clauses, and the distinction between them is important. A main or independent clause can stand alone as a sentence. A subordinate or dependent clause is just like a main clause except that it begins with a subordinating words such as because, if, who, or that express particular relationships between the clauses they introduce and the main clauses to which they are attached. Clauses that have been subordinated can never stand alone as sentences. Two kinds of subordinating words are used to connect subordinate clauses with main clauses. The first kind is subordinating conjunctions or subordinators. They always come at the beginning of subordinate clauses. Like prepositions, subordinating conjunctions are few and never change form in any way. The second kind of connecting word is the relative pronoun. It also introduces a subordinate clause and links it with an independent clause. Like subordinating conjunctions, relative pronouns link one clause with another. But unlike subordinating conjunctions, relative pronouns also usually act as subjects or objects in their own clauses, and two of them change form accordingly. Subordinate clauses function as adjectives, adverbs, and nouns. In understanding sentences that contain clauses, not only subordinate words can be used as the indication of the subordinate clauses, the substantive meanings (links between words) can also be used as references, as the clauses are often used to indicate the conditions and limitations of the links between words established by the main clauses. When constructing sentences, the executing system of the present invention may use structure rules to compose subordinate clauses to convey information as to indicate the conditions and limitations of the links between words established by the main clauses.

Belief values can be set up to reflect the fact that different people believe different connections between concepts (or different definitions of the concepts, especially for concepts that are abstract). Thus in one preferred embodiment of the present invention, the word (or phrase) element files includes links corresponding to different belief values, wherein a particular belief value represents a particular belief model. Thus links having the same belief value belong to the same belief model. When the robot system is used to conduct analysis or making argument, different belief model can be used to reflect different point of view.

Although in theory belief model is directly related to (or sustains) value rules (rules that regulate behavior, as of what to do and what not to do, often known as moral rules), in reality, the link between value rules and belief model is less certain. Thus, in present invention, the value rules are set up mostly independent from the belief model. Thus, no direct links between value rules and belief model are established (such as one particular belief value corresponding to a particular set of value rules), although some connections between belief model and value rules may exist. In one preferred embodiment of the present invention, the belief values are basically imbedded in the knowledge structure, while the value rules is established as part of the internal control rules of the executing system.

A knowledge system of the present invention may include various belief models and/or various types of value rules. The robot system using links with different belief values and/or apply various types of value rules may provide different results.

The human knowledge system is basically built on the elements that correspond to the sensory inputs, such as image inputs, sound inputs, touch inputs, smell inputs, and taste inputs. The smell and taste inputs are mostly related to the biological nature and needs of the human body. For purpose of simplification, discussion regarding smell inputs, and taste inputs are omitted in this application. But the process and embodiment of the process may follow the same principles as of the other sensory inputs.

Of all the sensory inputs, image inputs are usually most useful in establishing relationship of the objects in the outer world. Images can provide information such as shape and color of the objects and space relationship with other objects. Comparison of the image inputs in time sequence will also provide information of the movement of the objects. In image processing, the image inputs will first be processed to find identifiable elements or objects in the image inputs, and then either obtain information as to relationships of various objects or identify new objects, or often both.

The human knowledge system contains corresponding relationship between image elements and language elements. For example, children usually learn the word of apple when the image of apple is shown, or a real apple is being pointed at. Thus the sample of the image of apple is linked with the word apple. Often, many image samples having various features can be corresponding to the same language element in the human knowledge systems. To identify the real apple in the world, the image of the real apple will need to be matched with at least one of the sample images of apple. The matching process is basically a “visual thinking” process, i.e., a process that analysis various features of the images, and to compare the similarities and differences between the image input and the sample image in the human knowledge system. The features can be used to identify an object include color, texture, shape, size, and space relationship of various elements of the object. The “visual thinking” process of image matching can also use identification rules that generalized from the collections of the image samples (sometimes, information from other kinds of sensory input is also used in making identification rules). The identification rules are also related to the existence of other objects that are similar to this particular object. For example, an image of a pear may also be similar in size and color to an apple, as both have a stalk at the center top, but the shape of an apple is generally round while a pear is more like a cone, at least at the top half. The texture of the skin may also be different, wherein apple skin is more smooth, but pear skin is often more coarse and with speckles. Thus, the identification rules are part of the properties or attributes of the objects, and the “visual thinking” could also involve thinking with words. As identification rules cannot always be obtained directly correspond to each object, identification rules are often as supplemental method of image processing.

Objects exist in three dimensions, but sample images or image inputs are only in two dimensions. Thus, matching the sample images with the image inputs requires that sample images to be provided with various angles, and/or focusing on identifying features of the objects. Alternatively, sample images can be used to construct three-dimensional models that can be used to generate created sample images in various angles.

Depending on the purpose of the image processing, the image processing method can be different. For example, if the purpose of the image processing is to identify a particular object, then input images can be directly compare with the sample images or the created sample images. If the purpose of image processing is to identify all objects in the image input, then features of each portion of the image or basic image components in the image can be used to first narrow done the field of search for the sample images.

As identifying all objects in the image input requires first to assume the sample images that could match the input images, and then check to see if there is a match, the process is more complicated and time consuming, therefore, this type of task should be reduced to minimum. One solution is to build a world knowledge base that provide the most updated information of the objects in all possible locations that the robot system will be able to reach, and the images constructed by using these information can be compared with the input images, thus limited the task of guessing every objects in the input images. Or, object information in the world knowledge base can be used to narrow down the search for sample images that may match the input images, as the object information can not only indicate directly as to what object can be located in certain location, the object information in the world knowledge base can also indicate what type of environment the object is in, and infer that the what types of objects can possible be located in this environment. The inferring process is basically a thinking process (including assumptions and predictions) that uses some thinking rules (or other rules provided by the internal control mechanism) and the information in the object element files to obtain information of possible other objects in the environment.

Image inputs can also be obtained through various types of applications of technologies that the visual image input can carry some specific information about the objects. For example, X-ray photo can provide information about the internal parts of the objects, and thermal imaging camera can provide information about the surface temperature of the object, and radar can provide the relative locations and movements of the objects. The method for processing these image inputs can use the similar principles as for the ordinary image inputs.

When sound inputs are signals that are used to carry certain information, sound is more or less like language (spoken language is carried by sound signals). For this purpose, sound process is basically a pattern matching process wherein the absolute volume or pitch of the sound is not as important as the relationship among the sound input signals. Sound inputs can also indicate activities and/or movements of the objects, wherein certain sound input is related to certain object, or increase or decrease of intensity of the sound input can indicate the change of distance between the sound input device and the source of the sound.

The touch or other sense input (such as scan input, balancing sensor input) can be used for some specific purposes. For example, the touch sensor inputs can be used for surface contact information for various surfaces, as information can be obtained about which areas of the robot body are in contact with other object (or objects), and the area of contact and strength of the touch can indicate the shape and surface texture of the object that is in contact with the robot body. In another example, the balancing sensor can provide input signal to the robot system that indicates whether the robot body is balanced, so that to prevent the robot body from falling. As another example, laser scan input can be used to obtain distance of the robot from the obstacles in each direction, or as supplemental tools to obtain surface information of various objects in each direction.

Once the environment information and object information are obtained through image processing and other information processing, the robot system will establish “awareness” of the surrounding environment. The executing system of the robot system will be able to protect robot body from dangers in the environment by conducting self-protective actions and movements according to the internal control rules and action sequence files. The executing system can also direct the robot system to performance tasks according to commands and requirements from the input information. The actions of the robot system are basically movements of the robot body controlled by the executing system according the internal control rules and action sequence files. Actions of the robot system generally are realized by a combination of movements of various robot components. Rules that determine as to when, how and which robot component will move can be called action sequences, and action sequence files contains action sequences. The robot system can be established that the robot body can perform various actions/movements according to the predetermined action sequences. The action sequences can be identified by various ways, according to the purpose of the action sequences. For example, the action sequence that perform the act of running can be identified by the type of action (which is running), the surface feature (the type of objects that the robot interacted with), and the pace and speed of the action. In another example, an action sequence that controls both arms of the robot body to move an object from one location to another location can be identified by the type of action (which is moving a object using both arms), the body position of the robot, the starting position of the arms, the weight, shape and surface feature of the object, the initial position of the object, and the final position of the object.

Some action sequences may have variables, such that the action sequence can adjust to different features of the condition. For example, if pace and speed of the action sequence for running can be changed (meaning the robot body can perform at different speeds and paces using the action sequence), the action sequence can be identified as running, on certain surface feature, and pace and speed of running as variables. Certainly action sequences with variables are more convenient, as the action sequences can be used in different situations. Generally, variables for the action sequences have limitations, thus the action sequences cannot operate beyond the limitations. The limitations shall be indicated in the action sequence files.

If the task for the robot system cannot be performed by using the existing action sequence, the executing system will need to either combine more than one action sequence to perform the task, or perform the task by trial and error (i.e., using similar action sequence and revise the action sequence to perform the task). Often, the two approaches will be combined to find the new action sequence. In either case assumptions need to be made, and the assumptions can be made based on analysis of the currently available information, information such as similar action sequences, and the movement components of the action sequences. For example, if the existing action sequence files include information of the movements of each robot component, and the task is to use one arm to move one object from initial position to final position, but there is not existing action sequence file that matches the initial object position and final position (assuming the initial position and final position of the action sequence are not variable), then the executing system can find action sequence files that have similar initial position, and final position and analysis the action sequence files to find out movements of what robot body components are responsible for moving the object in the direction that may match the initial position and/or final position, and change the movement of the components to see whether the task can be fulfilled (the dimension of change can also be assumed by analysis the span of movement of the robot body components). As the action of moving an object by the arm will usually need to have an act of holding the object first, the newly obtained action sequence will also obtain an action sequence of the holding the object first, then moving from the initial position to the final position.

For action sequence files that have variables, but the task requirements exceed the ranges of variables, it is obvious that the action sequence files need to be used combined with other action sequence files, thus a search of the action sequence file can be conducted that initial position or final position (the position that exceeding the range of the first action sequence file) of the second action sequence file should match the initial position or final position (the position that exceeding the range of the first action sequence file) of the task, and the final position or initial position (on the other end of the action sequence) should match with the first action sequence initial or final position so that the two action sequences can be used in combination to perform the task.

Depending on the characteristics of the action sequence, the action sequence files are identified by various criteria. For example, the action sequence that involves the whole body movement of the robot generally starts and ends with default position and the pace, speed can be varied. The action sequence that involves only some body components is identified by the body components involved, the starting and ending positions of the critical body components, and possibly with the pace of speed variation.

Once the new action sequence is being used and tested, the new action sequence can be saved (or revised first according the feedback before saved) in a new action sequence file.

Decision making process is conducted by the thinking mode and according to the thinking rules. Decision making is necessary when different input will provide different and conflict results, or when the available information is not adequate to solve the problem and various assumptions can be made that will provide different solutions. In making decisions, different factors can be taken into consideration, thus the different processes will first be evaluated and obtain certain values for various criteria. The ultimate decision is made according to the internal control rules that provide that certain values and/or certain criteria are more important than other, that the process that contain the important value and criteria will be chosen.

The system and method of the present invention provides rule generating process (i.e., process that establish links between elements). The input, output, and executing process are saved as process files with specific identifying means. The system and method of the present invention may automatically inquiry new information according to internal control rules, and the knowledge structure.

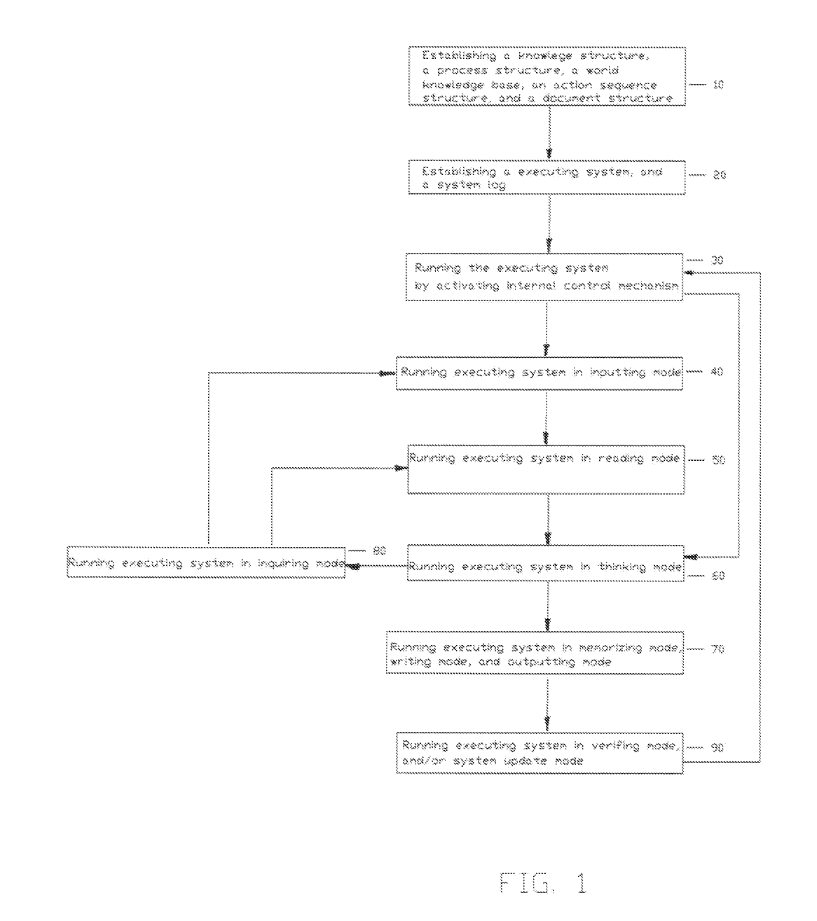

As seen in FIG. 1, the method of the present invention comprises the steps of:

Step 10a: establishing a knowledge structure including a file organizing mechanism, and more than one element files, wherein the element file includes identifying information and knowledge information;

wherein the identifying information identifies the elements, wherein the knowledge information includes knowledge about the elements, wherein the knowledge is information related to at least one direct links of the element with other elements of the knowledge structure.

In one preferred embodiment of the present invention, the process of building the knowledge structure of the present invention comprises the steps of:
building elements files wherein the elements are basic elements, wherein the basic elements generally represent objects in the outer world;
building element files wherein the elements are secondary elements, wherein the secondary elements generally represent concepts derived from the basic elements; and
building element files wherein the elements are third level elements, wherein the third level elements generally represent concepts derived from the secondary elements.

In a preferred embodiment of the present invention, the element files comprise objective links and subjective links wherein the subjective links may vary according to different belief values related to the subjective links. Alternatively, the system of the present invention may comprise objective knowledge system and subjective knowledge system.

In establishing the knowledge structure of the present invention, in one preferred embodiment, the words, phrases, symbols, images, sound recordings and other representational entities that more or less possess direct outer world implications will be established and defined first. Element file for elements that can be defined by using existing elements to describe will be established subsequently. This process can be continued until all human knowledge can found representation in the element files and links in the element files. The processes of building the element files and links are circular and new links between existing elements and new elements can be added to the element files of the existing elements as new elements are being added.

Step 10b: establishing a process structure comprising a process file organizing mechanism, and at least one process file.

The process files are identified by the types of processes, the inputs, the outputs, and the conditions of the processes. The process files basically are files for rules of the processes. The purpose of building the process structure that contains process files is to provide a mechanism that the process files can be generated, modified and expanded by the operation of the executing system of the present invention. The process file organizing mechanism can identify and locate the process files and provide access for the executing system to use the process files.

Step 10c: establishing a world knowledge base.

A world knowledge base is used by robot system to navigate and perform actions in the real world environment. The world knowledge base comprises world coordinate element files and world coordinate element file organizing mechanism. In a preferred embodiment of the present invention, the world is defined as the environment surrounding the earth, and the world coordinate is first established with a cardinal point and cardinal coordinate system with axes along the latitude, longitude and altitude, so that the location of any object is represented by a latitude value, a longitude value, and an altitude value. In the present invention, the world coordinate element files are files that have information about objects that located within the areas corresponding the world coordinate values. For example, a world coordinate element file may be a file for an area with the range of the latitude between x to y, the longitude between a to b, and the altitude between m to n, and the content of the world coordinate element file may include the world coordinate values of all the objects within this area, and the names of the objects (that can be linked to word element files that include information of the objects), and other corresponding information of the objects (especially information specifically related to this location).

To establish the world knowledge base, currently available geographic information such as maps can be used to build the world coordinate element files directly. For more detailed information, humans, robot or robots can be used to investigate area by area to obtain locations of objects in various areas and information of the objects. The world coordinate element files can be revised with new information later obtained, and the world knowledge base can be expended from the information later obtained by robots that use the world knowledge base.

Information obtained by the robot system about the location and other information for generally unmovable objects or objects that are not often moved are saved in the world coordinate element files of the world knowledge base and the element files of the knowledge structure. For many movable objects, information other than locations will be verified to find out if there are new information so that to establish new element files or new links in the existing element files to save the unique information, otherwise, the location and other information of the object may be saved in temporary/transitional/record files, or in the world coordinate element files with temporary status, and depend on the purpose of the robot system, and the nature of the objects, the information may or may not be used when the robot systeo constructs the preliminary world view in the future.

In another embodiment of the present invention, the world knowledge base includes corresponding relationship between each point at world coordinate system with un-moveable objects and last known moveable objects (geographic information, and environmental information). In one preferred embodiment, every object is given corresponding world coordinate values in latitude, longitude, and altitude, thus for any given location, depending on the purpose of the operation, a research within a range can be set for all the objects that have corresponding world coordinate values within the set range.

Indication or specification of the objects in the world knowledge base shall be specific enough that contains sufficient identification information. The name of each object should be unique so each object name is corresponding to a specific object file in the world knowledge base. The object file in the world knowledge base may contain shape (geometric information such as length, width and depth), color, material, common name and other specific information related to specific usage. The shape, color and material information along with the exact location of the objects can be used to generate background image for environmental investigation purpose. The common name can be used to retrieve additional information of the object (such as the various meaning and attribute of the object can be used to establish links with other objects or draw inference in strategic analysis and plan stage) from the knowledge system. Information of specific usage of the object can be used by the robot system to determine whether to include this object in its plan or whether special attention will be paid to this object.

The world knowledge base may further include world coordinate base maps. The world coordinate base maps are basically path maps that will assist to create paths between two or more points in the world coordinate system. For example, road maps, sea maps and air travel maps can all be used as path maps, thus the robot system can control automobiles, ships and airplanes. The world coordinate base map may also include more detailed information so that a robot can move around an environment like a human being or even in smaller scale (such as inside the human body, navigating the blood vessels). Thus different map can be provided for different purposes, and once the purpose is determined, a corresponding map can be selected as the base of the path planning. In one preferred embodiment of the present invention, a world coordinate base map includes map element files that contains information of the critical point in the map and directions to each destinations, wherein searches can be conducted to find the nearest critical points for the robot to move according to the directions indicated by the information in the map element files. Alternatively, a visual map (similar to the ordinary map) can be established for robot systems with the visual thinking (map reading) ability, so that the robot can use the visual map to determine paths of movements.

Step 10d: establishing an action sequence structure.

The action sequence structure comprises action sequence files and action sequence file organizing mechanism. The action sequence files generally are files that can be used to control movement of particular parts of the robot body to accomplish certain tasks. A action sequence file may be a combination of a series of action sequences (that will call for the corresponding various action sequence files) with a file name and/or identification information that represents the sequence (usually identified by the task to be completed, and features related to the conditions of the task). For example, an action sequence file named “running(pace, speed)” may include a series of action sequence files for all body parts that will be used to perform the action of running. Each of the action sequence file of the corresponding body part may include information regarding the movements of motors (or other actuation devices) such as angles, speeds and durations, or in the forms of electrical signal values, etc.

Step 10e: establishing a document structure comprising document entry files, document addresses, document contents, and a document organizing mechanism.

The document structure can be used for organizing documents within the robot system or documents in a broader environment (such as in the World Wide Web). In one preferred embodiment of the present invention, documents are summarized to obtain key words. The document entry files comprises key words (as file names) and containing lists of document names having the key words, and corresponding address information of the documents having the key words.

In another preferred embodiment of the present invention, documents are processed by the robot system (and/or with the assistance of human operators) to be divided into categories and sub-categories, and then the documents are organized according to the categories. The document entry files having category names as file names and include lists of document names belonging to the categories, and corresponding address information of the documents belong to the categories.

In another preferred embodiment of the present invention, documents are processed to obtain content word lists that the documents contain. The document entry files comprises content words (as file names) and containing lists of document names having the content words, and corresponding address information of the documents having the content words.

Step 20: establishing an executing system comprising an internal control mechanism and an inputting mode, a reading mode, a thinking mode, a writing mode, a memorizing mode, an outputting mode, an inquiry mode, verification mode, and a system update mode;

Establishing a system log;
wherein the inputting mode includes inputting rules, wherein the reading mode includes reading rules, wherein the thinking mode includes thinking rules, wherein the writing mode includes writing rules, wherein the memorizing mode includes memorizing rules, wherein the outputting mode includes outputting rules, wherein the inquiry mode includes inquiring rules, wherein the verification mode includes verification rules; wherein the system update mode includes system update rules;
wherein the internal control mechanism includes internal control rules, and structure rules;
wherein the internal control rules further comprises basic rules, target rules, value rules, determinative rules, responsive rules, and control rules.

The internal control rules generally designate the operating process of the executing system. The entire operation of the robot system is directed by various combinations of rules including internal control rules, and rules in various modes. The quality and ability of the robot system depends on the sophistication and complicity of the rules.

The structure rules relate to the grammar and sentence structures of the language. For example, structure rules provide various sentence structures of various languages that can be used for different purposes.

Step 30: running the executing system wherein the internal control mechanism can operate constantly, wherein the thinking mode, inquiry mode, memorizing mode, verification mode, and a system update mode can be activated according to the internal control rules of the internal control mechanism not triggered by an input;

wherein according to the thinking rule, direct link between a first existing element and a second existing element can be used to establish new direct links between the first existing element and at least one existing element with direct link with the second existing element;
wherein according to the thinking rule, process files can be used to establish new direct links between the existing elements.

Step 40: if input information is received from an inputting device of a sensing and information gathering system, the internal control mechanism will operate inputting mode according to the internal control rules, wherein the input information will be converted to format conformed with the format requirement by the executing system according to the inputting rules, wherein information other than language may be converted to language information by information processing tools, or information other than language may be pre-processed by the information processing tools to prepare for further processing by the reading mode.

Step 50: once input information is received and processed in the inputting mode by the executing system, the internal control mechanism will activate reading mode according to the internal control rules, wherein according to the reading rules, the input information (especially the language input) will be disseminated into elements and element files of the knowledge structure of the corresponding elements matched with the input elements will be located and loaded into the executing system (or areas easily accessible by executing system) according to the file organizing mechanism of the knowledge structure;

wherein when the input information is in language format, the reading mode will read the identifying information of the element files of each of the input elements according to the reading rules, wherein the structure rules of the internal control mechanism will determine sentence structure of the input to decide what kind of task the input is calling for, and determine corresponding internal control rules for operating the internal control mechanism;
wherein when the input information is a task command with specific format, it may directly trigger the structure rule of the internal control mechanism to determine corresponding internal control rules for operating the internal control mechanism;
wherein when the input information is in image format, the reading mode will be set to conduct image processing and use image processing tools such as pattern matching, the reading rules will direct the executing system to read the identifying information and link information of the element files of each of the identifiable image component of the image input so that to obtain more information to be used to identify more image components or objects, and so on, wherein the element files for the identified objects will be loaded into the executing system.

The knowledge of known objects from the world knowledge base can be used to create background or reference images, wherein an internal image generating process will generate the background or reference images according to the information of the world coordinate base element file of the world knowledge base. The input images or measurements can be compared with the background or reference images (created from the information from the world knowledge base) that only new and/or different information will be processed, which will save cost and time, and avoid confusion. Alternatively, the object information from the world coordinate base element file will give guidance in the image identification process.

In one preferred embodiment, in identifying process, assumptions can be make that most commonly appeared object in the environment will be given priority in the assumptions (similar to the process as provided by the thinking rules).

Step 60 if it is determined that a specific task is called for, the internal control mechanism will activate the thinking mode, wherein according to the thinking rules designated by the internal control mechanism, the thinking mode can establish new direct links between the existing elements of the knowledge structure that match with the elements of the input information according to the input information;

wherein the existing direct links between the existing elements that match with the elements of the input information and other existing elements of the knowledge structure in each of the said existing element file can be used to further provide new direct links between the existing elements that match with the elements of the input information and more other existing elements in the knowledge structure, the linking processes of the elements related to the input information with other elements in the knowledge structure can continue according to the direct links of the elements with other elements according to the element files of the elements, and update element files for elements linked with the input information;
wherein when the task calls for establishing a direct link between a first existing element and a second existing element, the direct links of the first existing element with other existing elements in the knowledge structure according to the element file of said first existing element will lead to the element files of said other existing elements that link with the first existing element, the direct links of said other existing elements that link with the first existing element with more other existing elements in the knowledge structure according to the element files of said other existing elements that link with the first existing element will lead to the element files of said more other existing elements that link with the first existing element, wherein the direct links of the second existing element with other existing elements in the knowledge structure according to the element file of said second existing element will lead to the element files of said other existing elements that link with the second existing element, the direct links of said other existing elements that link with the second existing element with more other existing elements in the knowledge structure according to the element files of said other existing elements that link with the second existing element will lead to the element files of said more other existing elements that link with the second existing element, wherein the linking process can continue until at least one direct link between the existing element that links to the first existing element and the existing element that links to the second existing element is found, wherein a direct link between the first existing element and the second existing element can be established by tracing back the linking process;
wherein the thinking mode search the process structure for process files, and using the process files to make new direct links between the existing elements;
wherein when no direct link between the existing element that links to the first existing element and the existing element that links to the second existing element can be found, the internal control mechanism can operate inquiry mode according to inquiring rules, wherein the inquiries can be sent to display device or output device to inquire information, wherein the input information responding to the inquiries will be processed by inputting mode, reading mode, and thinking mode to find direct link between the first existing element and the second existing element.

When no links can be found between the first existing element and the second existing element, the thinking mode of the present invention can made assumptions or predictions based on processes such as generalizations, inductions to established links between the first existing element and the second existing element. The rules of making assumptions and predictions can be varies depending on the elements involved and the purpose of the task, it also depends on whether the links include subjective links.

In one preferred embodiment of the present invention, the thinking process of the robot system will make distinctions between subjective links and objective links of the element files wherein determinations can be made based on the belief values related to the subject links.

The analysis process and further construction of the knowledge structure of the system of the present invention involves further discussion of the word links, human knowledge system, and human thinking process. The truth-functions (developed by philosophers such Bertrand Russell) can be used as the bases for making thinking rules for conducting deductive process so that to establish new links between elements of the knowledge structure.

For image inputs, the thinking mode may establish links of elements using word association (establishing links using links in the word element files corresponding to the image inputs) or conducting a process that can be called as “visual thinking”, wherein the relationships between image components or objects in the image inputs can be directly analyzed and results can be obtained using the appropriate thinking rules.

Various functions or decision-making routines relate to thinking rules, wherein the executing system of present invention can make decisions according to the input. For example, the executing system of the present invention can be set up to respond to outside changes for the purpose of self protection, or revise actions to fulfill predetermined goals. When the executing system of the present invention is used for controlling a robot body that is either standing still, or moving, the image input in one time segment can be compared with the image input from the previous time segment. If image for certain object is larger in the later image input, then probably the object is approaching the robot body, and the executing system can further conduct a calculation or estimation to determine the direction that the object is moving then to decide whether the robot needs to move or change the direction of movement to avoid collision with the object (For movable objects, comparing information obtained from different images or measurement, the lotus of movement of the object can be obtained).

For tasks that require the robot system to perform certain actions, the target position or positions need to be given either explicitly or implicitly (from Step 40 through 50), wherein the target position or positions can be obtained in or transformed to world coordinate format according to one preferred embodiment of the present invention. Then, the initial location of the robot by latitude, longitude, and altitude in the world coordinate system will be obtained either by direct measurement and calculations (going back to Step 40 through 60), or by information inquiries (going to Step 80 and back to Step 60), or from internal memory log (internal process of Step 60). Then executing system can obtain information related to this location (for example, whether the robot body is inside a room or outside, etc.) from the world knowledge base; then obtain information of the un-moveable objects near this location (depending on whether this location is within a room or open space, considering the obstruction of the view), and the last known movable objects near this location (depending on whether this location is within a room or open space, considering the obstruction of the view). The unmovable objects and last known movable objects will be used to construct background or reference images in this location. The world base map corresponding to both the current location and target location can also be obtained from the world knowledge base, thus an planned action path according to the current location, the target location, and the world base map can be planned. In some situations, the planned action path can be first verified by obtaining input from the input devices or making inquires and obtain information from other information sources and making revisions of the planned action path according to the new information. For example, the robot may be able to see that there are obstacles in the planned action path, thus revise the planned action path, or taking it into considerations when generating the action sequence. Otherwise, an action sequence will be determined according to the action path. The action sequence will be outputted to control devices to control movements of the robot body. During the moving process, the robot will continue requiring and receiving inputs and process the inputs, thus the thinking process may make revisions of the action path and action sequence accordingly, and send the revised action sequence to control devices to control movement of the robot body accordingly.

The robot system may decide to move to another location through interpretation of the input information according to internal control rules of the present invention. In this case, the target position may be determined by the thinking process, and may also be changed according to the new input information.

When the robot is in an indoor environment, the path information may often be changing or not complete. Thus, there might be a need for instant path generation. In this case, all the object shapes and locations in the range for the path can be used to generate plan view drawings so that areas occupied by any objects will be assigned certain values while areas not occupied will not be assigned with a different value. Thus a path map can be generated within the area with the value assign to blank space.

Once the action path is determined, the action sequence can be determined. Generally speaking, the action sequence is generated by combining and/or modifying various predetermined or pre-calibrated sub-sequences from the action sequence files, and sub-sequences can be generated by trial-and-error at the spot then be repeated in the entire operation. For example, there should be several walking sequences for a particular robot system (in different direction, carrying different things, etc.) When a robot is carrying a thing that the weight and shape combination is significantly different from the existing subsequence, one sequence that is most similar could be selected, then the robot system can try to operate following a few practice sequences that are variations of the sequence selected, to learn how to keep balance, pace, directions, etc. by trial-and-error through feedback from the balancing and touch sensors. Once workable sub-sequences are obtained, the robot can repeat and combine these sub-sequences during the task and save the sub-sequences as the action sequence files for further use.

In fact, the entire task sequence can be saved as the action sequence files for future use. Thus if the robot is asked to perform the same task again, it will only need to recall the task sequence and repeat the entire process and only make modifications responding to input information as needed. Thus the robot system of the present invention can perform many repetitive identical tasks in automatic process while containing the ability to adapt to various task requirements and environments.

In general, the thinking mode may contain several different types of thinking rules that relate to the types of conditions or purposes of the system. When a goal is specifically provided, and the goal is obtain information, then either deductive process, or assumption, using generalization or inductive process can be used to reach the goal. If the goal involves action, then first environmental investigation needs to be conducted, and a strategy can be established by evaluation and decision making, later the execution of the strategy may involve revision according to more input information or environmental changes.

Step 70: wherein the new direct link between the first existing element and the second existing element can be saved to the element file of the first existing element and the element file of the second existing element by the memorizing mode according to the memorizing rule, wherein the linking process for linking the first existing element with the second existing element can be saved as a process file to a process structure by the memorizing mode according to the memorizing rule, wherein information including the new direct link between the first existing element and the second existing element can be written to a display device by the writing mode according to the writing rules and the structure rules of the internal control mechanism, wherein the new direct link between the first existing element and the second existing element can also lead to information other than language and be outputted as control signal to output device by the outputting mode according to the outputting rules.

The outputting mode generally controls the actuation system of the robot system, wherein action sequence will be generated according to the input information and goal position of the action, wherein the achievement of goal position, or success establishment of working action sequence may be established by repeating step 40 through 70.

Step 80: wherein the internal control mechanism can operate inquiry mode according to the internal control rules, wherein the inquiries can be sent to display device or output device to inquire information, wherein the input information responding to the inquiries will be processed by inputting mode, reading mode, and thinking mode, and memorizing mode to establish new direct links between the existing elements, new direct links between new elements and existing elements of the knowledge structure, and new element files.

The inquiry mode may also inquire information from the document structure wherein the document structure can search for and obtain information to establish new links between existing elements, or to establish new element files.

Step 90: if new links and/or new element files and/or new process files are established, the internal control mechanism can operate the verification mode to verify new direct links and the new linking processes; the internal control mechanism can also operate the system update mode to update the internal control rules, the structure rules, and the process files in the process structure, wherein the system operator's participations are often needed;

Wherein the internal control mechanism can save the operating process of the executing system to system log files in the system log according to the internal control rules.

Knowledge of occurrences of events, especially in time sequence, may have specific significances (especially with regards to the knowledge of “self” (the robot system in this case)). Accountability, or the consciousness (i.e. memory) of the robot system realized through utilization of system log, wherein the robot system will be able to record and recall all processes of the robot system.

In a nutshell, the process of building the human knowledge system generally includes a few steps: observation, speculation based on observation and deductions from the existing knowledge system, verification of the deductive results of the speculation, proposition based on critical evaluation and selection of various speculations, systematic evaluation and selection of the proposition, systematic verification of the proposition, revision of the proposition based on results of the verification, and so on. These steps can be reflected in the making of the robot system that is truly intelligent.

The robot system of the present invention establishes connections with the outer world primarily through language intake, image acceptances as in humans, it can also can obtain information through touches or other measurement such sonar or laser scan. The key for obtain useful information of the outer world is to establish a system of processing the immediate raw information to obtain essences of the objects and relationships between the objects.

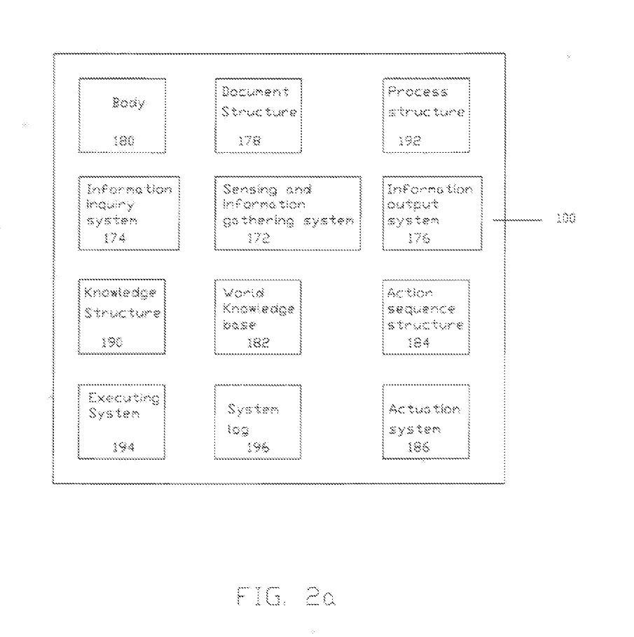

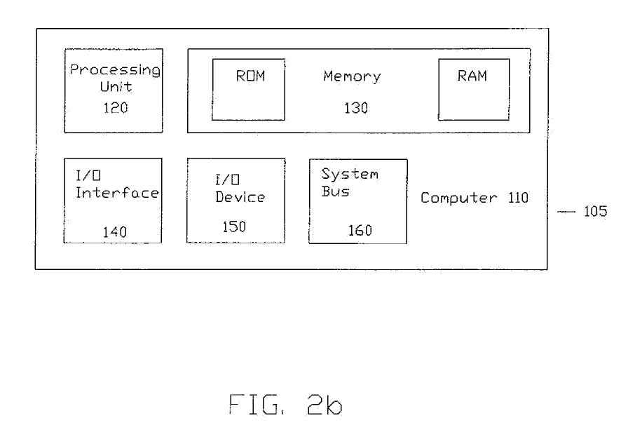

In one preferred embodiment of the present invention, as shown in FIG. 2a, the robot system 100 comprises: a body 180, a sensing and information gathering system 172, an information inquiry system 174, an information output system 176, a knowledge structure 190, a process structure 192, a world knowledge base 182, an action sequence structure 184, a document structure 178, an executing system 194, a system log 196, and actuation system 186.

In one preferred embodiment of the present invention, as shown in FIG. 2b, a computer hardware system 105 is used as part of the embodiment of the present invention that includes at least one computer 110, having at least a processing unit 120, a memory 130, an I/O interface 140, an I/O device 150, and a system bus 160 that interconnects various system components to the processing unit. The memory includes at least one read only memory (ROM) and one random access memory (RAM). A basic I/O interface, containing the basic routines that help to transfer information between elements within the computer, such as during start-up, is stored in ROM. The system bus comprises bus structures such as address buses, data buses, and control buses.

In this embodiment, the sensing and information gathering system 172 includes I/O devices 150 that provide input to the computer 110, and the information inquiry system 174, the information output system 176, and the actuation system 186 are I/O devices 150 that the computer 110 provides control. The body 180 can be actuated by the actuation system 186. The knowledge structure 190, the process structure 192, the world knowledge base 182, the action sequence structure 184, the document structure 178, the executing system 194, and the system log 196 are mostly software systems that are contained in the memory 130. The operation of the executing system 194 is mostly realized through the operation of at least one processing unit 120.

The sensing and information gathering system 172 may further comprises a word input system, an image input system, a sound input system, a touch/scan input system, and world coordinate position measuring system (using devices such as Globe Positioning System (GPS) to obtain positions of the Robot system in the world coordinate system).

In a preferred embodiment, the knowledge structure 190, the process structure 192, the world knowledge base 182, the action sequence structure 184, the document structure 178, the executing system 194, and the system log 196, can be duplicated.

### Knowledge Structure

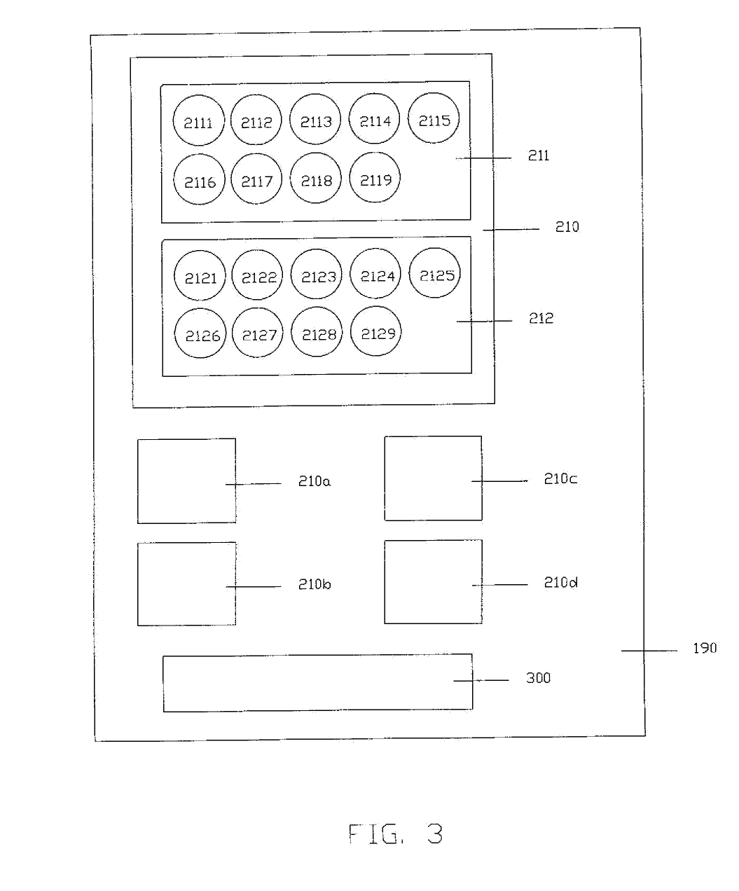

In one preferred embodiment of the present invention, as shown in FIG. 3, the knowledge structure 190 of the present invention comprises knowledge files and file organizing mechanism 300.

The knowledge files comprises numerous element files 210. Each element file 210 comprises an identification file 211, and a link file 212.

In a preferred embodiment, the identification file 211 comprises a first identification value 2111, a second identification value 2112, a third identification value 2113, a fourth identification value 2114, a fifth identification value 2115, a sixth identification value 2116, a seventh identification value 2117, a eighth identification value 2118, and a ninth identification value 2119. Different identification values of an element file can trigger different actions of the executing system 194.

In one preferred embodiment, the first identification value 2111 indicates the first element file 210 is a file for a word. The second identification value 2112 indicates what type of language is the word. In general the first identification value 2111 of a element file 210 could indicates whether the element is a word, a phrase, a sentence, a paragraph, a collection of paragraphs, even a book, a process, a symbol, a graphic, a formula, a sound or some other type of record.

The third identification value 2113 indicates whether the word is a noun, a verb, a pronoun, a verbal, an adjective, an adverb, an article, a preposition, a conjunction, or an interjection. In general, the second identification value 2112 through the ninth identification value 1119 could be any feature indication or a blank value.

The fourth identification value 2114 indicates the classes of nouns, verbs, pronouns, adjectives, and adverbs. The nouns are divided into classes including common nouns, proper nouns, collective nouns, count nouns, mass nouns, concrete nouns, abstract nouns. The verbs are divided into classes including transitive, intransitive, linking verbs, and auxiliary verbs. Pronouns fall into several classes including personal pronouns, indefinite pronouns, demonstrative pronouns, the relative pronouns, intensive and reflexive pronouns, intensive pronouns, reflexive pronouns, interrogative pronouns. Adjectives are divided into descriptive adjectives, limiting adjectives, possessives, words that show number, demonstrative adjectives, interrogative adjectives, and numbers, proper adjectives, attributive adjectives, predicate adjectives. Adverbs can be divided into classes of modifiers of verbs, adjectives and other adverbs; sentence modifiers. Words of different classes represent different meanings, usage, and corresponding sentence structures.

The fifth identification value 2115 indicates the forms of nouns, verbs, pronouns, adjectives, and adverbs. Nouns have forms in subjective and objective case, possessive case, and plural. Verbs have forms of simple, past tense, past participle, present participle, and -s form. Pronouns have forms of subjective, objective, possessive. Adjectives have three forms: positive, comparative, and superlative. Adverbs have three forms: positive, comparative, and superlative. Words in different forms reflect their functions, usage, and corresponding sentence structures.

The link file 212 indicates the connections the element has with other elements. The link file 212 comprises a first link information file 2121, a second link information file 2122, a third link information file 2123, a fourth link information file 2124, a fifth link information file 2125, a sixth link information file 2126, a seventh link information file 2127, an eighth link information file 2128, and a ninth link information file 2129.

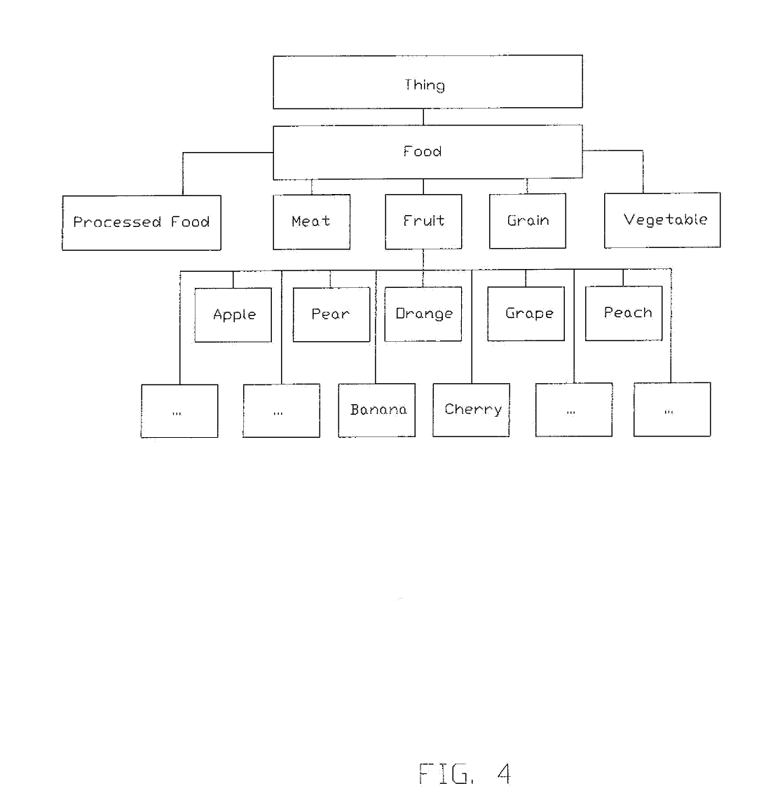

In a preferred embodiment, the first link information file 2121 establishes vertical connections between words. The first link information file 2121 comprises a word tree field, and an information field. The word tree field contends one or more groups of words connected by a tree like structure, wherein the word in the top of the tree structure is most general in meaning. Going down the tree structure, the words will be more specific in meaning. Preferably, the word tree structure should contain all words that have vertical connection with this element. For example, for the element file for fruit, the word tree field may contain thing, food, fruit, apple, pear, orange, etc. as indicated in FIG. 4. In general, a word in lower level should be able to replace the word in the upper level in just about all sentences. If in some situations there are exceptions (usually when words in the word tree fields have multiple meanings, and only one meaning related to the word of the element file), these exceptions should be provided in the information field. If the word of the element file has more than one meaning, more than one word tree can be provided in the word tree field, and the condition or usage of the different word trees will be indicated in the information field. Phrases can be treated like words as for elements of the element files, or in the element files, with indication that they are phrases functioning as words.

The first link information file 2121 would likely be blank for pronouns, propositions, conjunctions, interjections, and articles.

The second link information file 2122 establishes horizontal connections between words. The second link information file 2122 comprises word field, and word information field. The word field contains words that are interchangeable with the word of the element file 210. If in some situations there are exceptions (for example, when the word has different meanings), these exceptions should be provided in the word information field. The words that have similar meaning with the word of the element file 212 can also be included in the word field, wherein the word information field will contain the differences in meanings and functions of the words. The word field may also contain the words in different forms with the same meaning as the word of the element file 210, wherein the word information field will indicate difference in usages and functions. The word field may also contain words in other languages that have similar meanings as the word of the element file 210, wherein the word information field will indicate the usage and corresponding sentence structures information, etc. Phrases can be treated like words as for elements of the element files, or in the element files, with indication that they are phrases functioning as words. The second link information files are especially useful for nouns, verbs, pronouns in related to different forms, or tenses, or moods, or voices and their usages.

Pronouns are used as the replacement of nouns. The second link information file 2122 for a pronoun will indicate the noun or nouns that the pronoun is equivalent in meaning and usage to. Difference forms can also be indicated with the information in different usages and functions.

The second link information file 2122 would likely be blank for propositions, conjunctions, interjections, and articles.

The third link information file 2123 establishes the way the word will be used in a sentence. The information in the third link information file 2123 usually contains information for the specific ways the word is used in sentences. The third link information file 2123 comprises a link field, and a link information field. For nouns, pronouns, the link field may contain their effects on verbs to change forms, the specific words they can be associated with, and specific changes in the sentence structure. For a noun, this file may indicate the link between the phrases that contain this noun with other words. For a verb, the link field may contain sentences that reflect the sentence structures of which the verb can be used. By using the words (nouns, pronouns, other verbs, etc.) that are most general in meaning to construct the sentences, the links between this verb and other words can be established. The link information filed indicates the condition for the verb can be used in these sentences. For example, for the word “eat”, the link field may contain: “Animals eat food. I eat food. I am eating food now. I ate food in the past. I have eaten food before. Animal eats food.”

The third link information file 2123 can also establish links for words in different groups but have related meaning. For example, verb “act” is related to noun “action”. This link can be indicated in the third link information file 2123 for both words.

For propositions, conjunctions, interjections, and articles, the third link information file 2123 may indicate the functions of the word of the element file in the sentences. A proposition always connects a noun, a pronoun, or a word group functioning as a noun to another word in the sentence. The noun, pronoun, or word group so connected is the object of the preposition. The preposition plus its object and any modifiers is a prepositional phrase. The third link information file 2123 of a proposition may contain commonly used prepositional phrase wherein other words in the phrases are in most possible general terms in meanings.

The fourth link information file 2124 establishes the conditions or occurrences that will cause the action or condition represented by the word. This file can be blank for the word of the element file that is a noun, pronoun. For verbs, this file can provide information as to why the action takes place. The link between the cause and the word of the element file can be absolute, i.e., if the conditions or occurrences are true, then the action that is represented by the word of the element file will occur. This is often represented by “if and then” phrase, and other words in the sentence should be the most general type of the words. For example, for word “rotate”, one sentence in the fourth link information file 2124 could be: “if a net eccentric force is applied to an object, then it will rotate.” You can see this type of links usually exist for natural occurrences. Sometimes, the link may or may not be true, depend on certain conditions. For example, for the word “boil”, one sentence establishes the link could be: “if the water temperature is 100° C., then it will be boiling in the normal atmosphere.” In this case, the temperature and pressure are both conditions for the water to boil. For some words, especially the words reflect the mental states or the actions of humans, or other living things, the links are not as certain. Then the sentences that reflect these links should reflect these uncertainties. For example, for the word “laugh”, one of the sentences establishes the link could be: “if one finds something interesting, then it is possible that this person will laugh”. The possible link could also be expressed using “because”: “Because I found something interesting, I laughed.” There could be more than one conditions or occurrences that will cause the action represented by the word. Therefore, the fourth link information file 2124 could contain numerous if-then sentences.

For adjectives, the fourth link information file 2124 may provide information why the condition exists. The link between the cause and the condition can also be absolute, conditional, or a possibility. For example, for the word “wet”, one sentence establishes the link could be: “if it rains, then the ground will be wet”. For the word “rotatable”, one sentence establishes the link could be: “if the object is not fixed, then it is rotatable”. For the word “red”, one sentence established the link could be: “if the a person is embarrassed, the person's face could turn red.” The fourth link information file 2124 may also provide information why the condition exists for adverbs.

The fifth link information file 2125 establishes what will be the result of the action represented by the word. This file is for verbs mostly. The link between the word and the result can be absolute, conditional, or a possibility. The sentences could also be in the format of “if-then”. For example, for the word “burn”, one sentence establishes the link could be: “if a piece of material is burning, then it will consume oxygen.” For the word “hit”, one sentences establishes the link could be: “if an moving object is hit, then it will change directions.” For the word “run”, one sentences established the link could be: “if a person is running, then this person may be sweating.” As for the fourth link information file, there should be numerous links in the fifth link information file for the most time. It is the goal of the link files, as well as of the fourth link information files and the fifth link information files, to establish all possible links between words or phrases through direct links and indirect links.

The sixth link information file 2126 contains identifying attributes and informational attributes of the word. The attributes are words that describe the characteristics of the word of the element file. Generally speaking, the sixth link information file 2126 is for nouns, and maybe verbs. The contents are words that define the fields and defined fields with or without values. For word that is general in meaning, most of the defined fields will not have values. For word that is the most specific, all the fields may have values. For example, a word “person” will have information attributes such as birthday, height, weight, blood type, education, number of brain, arms, etc., but most of field will be blank, except for one brain, two arms, etc. For a word “Elvis”, his birthday, blood type, education, etc, will all have a value. But here you can see the word “Elvis” is not the most specific, only if when you say “Elvis at 10:01 Jun. 1, 1951”, will you have the actually weight information. Words less general in meaning share the attributes for words that are more general in meaning linked by the word tree, but words general in meaning usually do not share all the attributes of the words less general in meaning linked by the word tree. Alternatively, the attribute information can be expressed in plain language. The identifying attributes usually are attributes with values that are unique to the element. The informational attributes can be in any thing related to the element. The format for the attributes can be as sentences or tables or forms, formulas, etc.

It can be noticed that if an attribute (especially an identifying attribute) of a word that does not have a value is assigned with a value, it will be equivalent to a word that is less general in meaning and linked by the word tree. For example, “person” is more general than “teacher” and linked with “teacher” by the word tree. So, a person who teaches will be a teacher.

People or places may have the same names but have different attributes. For example, John Smith is a frequently used name for many males, but they will have different birthdays, different heights and weights, and different occupations, and different personal characteristics. Paris in France is totally different from Paris in Texas of United States. The differences in the attributes may be reflected in separate and distinguish files in the sixth link information files, but it may be better that different element files are established for each person or place. These element files can be arranged in sub-element files under the same general names, and distinguished by distinct attributes.

Adjectives and adverbs usually indicate where, when, how, or to what extent, these features can be defined attributes of the nouns or verbs. Many adjectives can provide values or information of the attributes of the nouns. For example, green can be the color of an object, such as Granny Smith apple. Therefore, green can be value of the color attribute of the Granny Smith apple.

The seventh link information file 2127 establishes connections between word that indicates attributes of other words with those other words. This link information file indicates links that is the reverse side of the sixth link information file 2126. If a word is usually used as attribute or description of other words, then this file identify the word that this word defined or being attributed for. To reduce the size of the file, if the word is an attribute for a group of words linked by word tree, the seventh link information file 2127 may include only the word most general in meaning. For example, the word color can describe a physical existence, i.e., a thing. Therefore, seventh link information file 2127 may indicate that color is an attribute of a thing. It does not need to including other words that are less general in meaning and linked with “thing” by word tree, such as, tree, apple, chair, human, etc.

The comparative form or superlative form of adjectives and adverbs establish links for objects with similar values of the attributes.

The eighth link information file 2128 indicates the derivative attributes or derivative values of the word of the element file. For example, for word “place”, geographic location will be attribute for the place, and derivative attributes will be distance of this place with other places.

The ninth link information file 2129 indicates the connections between word that indicates the derivative attributes of other words with those other words. This link information file indicates links that are the reverse sides of the information indicated by the eighth link information file 2128. If a word can be used as derivative attribute of other words, then this file identify those other words. To reduce the size of the file, if the word is a derivative attribute for a group of words linked by a word tree, the ninth link information file 2129 may include only the word most general in meaning in the word tree.

The fourth link information file 2124, the fifth link information file 2125, the sixth link information file 2126, the seventh link information file 2127, the eighth link information file 2128, and the ninth link information file 2129 would likely be blank for propositions, conjunctions, interjections, and articles.

Other link information could be indicated in these link information files or other link information files.

If the element is a phrase, the first identification value 2111 indicates it is a file for a phrase. The second identification value 2112 indicates what type of language is the phrase. The third identification value 2113 indicates whether the phrase has the function of a noun, a verb, an adjective, an adverb, a preposition, a conjunction, or an interjection.

The link information file for a phrase will be similar to the file for the word that the phrase is equivalent in functions for. One specific difference is that the phrase can have most simplified form and more complex form. Generally, adding more words besides the key words will make the phrase more complex, and provides more specific meaning. The different form for the phrase can be provided in the first link information file and/or second link information file of the phrase.

Prepositional phrases usually function as adjectives or as adverbs, occasionally as nouns. The link information file for prepositional phrases may contain adjectives, adverbs, or nouns that they are similar to in meaning and function. The link information file may also contain information for special uses of the preposition!1 phrases in sentence.

Participles, gerunds, and infinitives—like other forms of verbs—may take subjects, objects, or complements, and they may be modified by adverbs. The verbal and all the words immediately related to it make up a verbal phrase. Like participles, participial phrases always serve as adjectives, modifying nouns or pronouns. Gerund phrases, like gerunds, always serve as nouns. Infinitive phrases may serve as nouns, adjectives, or adverbs. Because participle phrase could have same form as gerund phrases, the phrase link information file may have more than meaning and/or function depending on the how they are used in sentences.

Absolute phrases consist of a noun or pronoun and a participle, plus any modifiers. Special use or meaning of the absolute phrases should be indicated in the link information file.

If the element is a symbol, a graphic, a sound or some other type of record, the second identification value 2112 through the ninth identification value 2119 could be any feature indication or a blank value. The element files may contain the link between each other, the link between it and a word or phrase, and other information related.

For a symbol, it may help to identify sentence structures, meaning and function of words and phrases, these information may be indicated by identification values and link information files.

In one preferred embodiment of the present invention, the element files for words comprise objective links and subjective links wherein subjective links may vary according to different belief values of the subjective links. Alternatively, the present invention may comprise objective knowledge system and subjective knowledge system.

The element files generally have words or word phrases as file names, thus processing conducted by executing system that involve searching the element files will be accomplished by searching the element files that have the words or word phrases as file names. The word element files may include image information such as the corresponding image files, but image element files generally have special characteristics, and especially for file organizing and search purposes, an image library having distinguishing image element file organizing mechanism can be established. Similarly, a sound library having distinguishing sound element file organizing mechanism can be established; and a touch/sense library having distinguishing touch/sense element file organizing mechanism can be established

In one preferred embodiment of the present invention, an image library comprises image element files and image file organizing mechanism. Each image element file has an image element file name, and an image element file content compriskng an image information file, an identification file and a link file. In one embodiment, the image element file name of the image element file is a word or word phrase, wherein the word or word phrase generally represents the object or symbol that relates to the images in the image element file. The image file organizing mechanism can identify the image file name with type, and one or more categories, and subcategories that can be used when searches for the image element file to match the image input. This can be achieved by method such as providing lookup table in the image file organizing mechanism that indicates the types, and categories, and subcategories the image element file with the image element file name belongs to. The type, categories, and subcategories can be established based on the simplicity of the images, and the features of the images such as identification features (features that can distinguish the images of this image element files from other images). (For this embodiment, the image library can be directly incorporated into the knowledge structure, wherein the file organizing mechanism will identify the image element file separately and using the search method of the image file organizing mechanism.)

The image information file of the image element file includes image related information of the object or symbol that relates to the image element file. The image related information may include size, shape, color, material (including surface texture), etc. In one preferred embodiment of the present invention, the image related information should be in the format that the executing system of the present invention may be able to use to construct three dimensional object from the image related information and generate images from different angles (for the objects that corresponding to images in the image element files). The image related information may also be sample images (especially for the image element file that relates to information about two dimensional images).

The identification file comprises a first identification value, a second identification value, a third identification value. The contents of the various identification values of an element file can trigger different actions of the executing system. The first identification value can be used by the image file organizing mechanism to either identify the image element file with certain category or confirm the category that the image element file belongs to (thus, the first identification value may identify the element file as an image element file, and the type of the image element file). The second identification value, the third identification value (and any other subsequent identification values that are needed for identify the category of the image element file) can be used to identify the category and subcategory of the image element file that can be identified by the image file organizing mechanism. For example, the first identification value of the image element file may indicate whether the image element file is a simple image element file. The second identification value of the image element file may indicate what image category that the image element file belongs to, such as circle, square, etc. The third identification value of the image element file may indicate what image subcategory that the image element file belongs to, such as square within circle, irregular within square, etc. The image element file may belong to more than one categories or subcategories, so that the identification values of an image element file may have more than one values on each level.

The link file indicates the connections the element has with other elements. The link file comprises a first link information file, a second link information file, a third link information file, etc. In this embodiment, as the image file name of the image element file is a word or word phrase that represent the object or symbol that the images in the image element file relate to, the link between the image element file with the word or word phrase is established by the image file name. Thus the link file does not necessarily need to indicate the link between image element file and the object that the images in the image element file relate to. In this embodiment, the first link information file establishes vertical connections between objects and/or symbols and/or images. The first link information file comprises an object/symbol/image tree field, and an information field. The object/symbol/image tree field contains one or more groups of object/symbols/images in a tree like structure indicating the connections among them, wherein the object/symbol/image at the top of the tree structure contains objects/symbols/images that are below and connected with the object/symbol/image that are at the top of the tree structure. In the tree structure, the objects, symbols and images are represented by the corresponding image file names of the image element files that represent the objects, symbols and/or images. For example, a human head includes two eyes, a nose, a mouth, two ears, and hair. And, an image (or symbol) of star includes numerous angles (or lines). The first link information file can be helpful for identifying objects in the input images. For example, if the initial image processing of the image input identified one or especially two ellipse shaped image components, the image file organizing mechanism can match the image components with image element file of ellipse, and because the first link information file of the image element file of ellipse indicates that eye image contains ellipse, and human head contains eyes, thus the executing system of the robot system can use image element files of eye, head, and even human body to identify more image components of the image input.

There are some difference in the nature and usage of the tree structure in the image element file and the tree structure in the word element file. Links established relate to words that are more generally in meaning can be used in deductive process to establish links relate to words that are more specific in the tree structures of the word element files. When using image library to read image inputs, simple image elements are first identified, and the tree structures of the image element files of the simple image elements can be used to select more complex image element files that could be matched with components of the image inputs. Simply put, the usage of the tree structure of the word element file is from top down, while the usage of the tree structure of the image element file is from bottom up. This is reflected in the structure of the tree structures, while the tree structure of the word element file branches out from the top to bottom, the tree structure of the image element file branches out from the bottom to the top. The information field of the first link information file indicates exceptions of the connections, or conditions of the connections.

The second link information file can be used to establish horizontal connections between objects/symbols/images, i.e., the links between the object/symbol/image of the image element file with other objects/symbols/images that are similar in shapes and sizes. The second link information file comprises a link field, and a link information field. The link field usually contains objects/symbols/images that are similar in shapes and sizes with the images of the image element file. The link information field usually indicates the conditions or exceptions of the links. For example, circles can be seen as ellipses from different angles, and vise versa. Therefore, the second link information file can be used by the executing system to identify more image components or objects in the image inputs.

The third link information file establishes other connections between objects/symbols/images. The third link information file comprises object/symbol/image field, and object/symbol/image information field. The object/image field indicates other objects/symbols/images that usually appear with or near by the object/symbol/image in the image element file, the object/symbol/image information field indicates the conditions and relationships of other objects/symbols/images with the object/symbol/image in the image element file. For example, a nose usually is below two eyes and in between two eyes in a front view human face, and a mouth will be below the nose and align with the nose, so that the image element file of nose or mouth can be used by the executing system of the robot system to identify image components in the input image, such as eyes, etc.

It is possible to use a fourth link information file, a fifth link information file, etc. to establish other kinds of links between the object/symbol/image of the image element file with other objects/symbols/images. The purpose is to try to obtain information from some identifiable image components or objects and use this information to identify more image components or objects.

In another preferred embodiment, the image file name of the image element file is a symbolic representation of images of the image element file or a name that represents the characteristics that the image file organizing mechanism will be able to recognize. For example, the image file name of the image element file may be designated to identify the type, category and subcategories of the image element file, so that when the image file organizing mechanism scans the image element file name index of the image file organizing mechanism, the image file organizing mechanism can obtain information about the type, category and subcategories that the image element file belongs to, and decide what image element files will be selected to match the image components of the image input, thus narrows down the search scope of the matching image element files for the image input. As an example, the image file name of the image element file could be “isc23”, representing the meaning that the image element file is for images (in two dimensions, as oppose to objects, that are in three dimensions) that are simple image type (as oppose to complex images), in the circular category, and in the subcategory “2”, and sub-subcategory “3” (that can be the indication of the kind of curve that the image, or images are, and the shapes of the internal components, etc.).

In this alternative, since the image file name is not the word or word phrase corresponding to the image/symbol/object relates to the image element file, the link between object/symbol/image with the word or word phrase needs to be established. The first link information file may indicate the word or word phrase that is corresponding to the object/symbol/image of the image element file, while the second link information file indicates the vertical link between objects/symbols/images, the third link information file indicates the horizontal link between objects/symbols/images, and so on.

A sound library can also be established using similar principle as building the image library. Generally speaking, sound signals do not necessary have corresponding word or word phrase designation. Thus, sound file names can be designated as the indication of types, categories, and subcategories that the sound element files belong to, so that sound file organizing mechanism can obtain information about the types, categories, and subcategories that the image element files belong to by reading the sound file names. The sound information file may include information about the relative values of the sound sequence (as per pitch), possible range of the pitch, volumes, and other specially characteristics that can specially identify the sound signal/sequence. Methods such musical scores can be used to indicate the sound information.

The first link information file may indicate the alphabet, word or word phrase that the sound signal corresponding to (in cases that particular sounds are the pronunciation of certain alphabets, words, or word phrase. The second link information may indicate the particular activities or entities that could be the sources of the sound signals. For example, sound signals that correspond to alphabets, words, or word phrases are generally uttered by humans in the acts of speaking or singing (sometimes by devices, that are made by humans), thus the sound signals can be linked with humans (or human-made devices). This information can be used by executing system for identifying objects in the environment, since by detecting the direction of the sound input, the executing system can assume that humans or human-made devices may exist in that direction, and then conducting image processing with sample images of human and/or human made devices, thus accelerate the image process and over all information process.

The third link information file may indicate the vertical connections between sound signals/sequences. Here, the connections between sound signals/sequences can also be indicated by tree structures. For example, a particular music segment can be a part of music lyric, which in turn can be a part of different musical pieces. The fourth link information file may indicate sound signals/sequences that are similar to the sound signals/sequences of the sound element file. This link information may be especially useful in voice recognition, since different people varies in their pronunciation, variations from standard pronunciation can be detected and/or confirmed by using the information in the fourth link information file. The fifth link information file may indicate other connections between sound signals/sequences. For example, when animals use particular calls for mating, the calls are often followed by responses, thus the fifth link information can be used to obtain another sound element file to be used to better and faster process sound input.

The touch/sense information may be a little different. Depending on the complicity of the touch/sense sensors, touch/sense signals/sequences can provide different levels of information related the objects and activities that trigger the touch/sense signals/sequences. Generally, the robot system includes more than one touch/sense sensors (often numerous sensors), and the locations of the sensors that sense the touch/sense signals (sometimes even the sequences of the sensors that sense the touch/sense signals especially when the robot body is moving) are relevant to the space information of the objects in the environment of the robot body. The touch sense signals can also be used to indicate the relationship between the robot body (or a part of the robot body) with other objects (or with other parts of the robot body). For example, the touch/sense signals of the robot foot will indicate the condition of the contact that the foot has with the ground; and the touch/sense signals of the robot hand will indicate the condition of contact that the hand has with the object that the hand is holding or trying to hold. The touch/sense signals are often used to supplement information obtained through image inputs. Some information what can be obtained by the touch/sense sensors may only be obtained by the touch/sense sensors, such as temperature, or softness, etc. This information can be used in other types of element files. Generally speaking, information regarding objects can be used in all the element files representing the objects.

In one preferred embodiment of the present invention, the touch/sense element file may indicate the appropriate combination of the touch/sense signals received by various touch/sense sensors of the robot body when conducting various activities. The touch/sense element files may also correspond to action sequence files, as the conditions or responses of the operations of the actions, or the touch/sense information becomes part of the action sequence files as conditions or responses of the operations.

### World Knowledge Base

A world knowledge base is used by robot system to navigate and perform actions in the real world environment. The world knowledge base comprises world coordinate element files and world coordinate element file organizing mechanism. In a preferred embodiment of the present invention, the world is defined as the environment surrounding the earth, and the world coordinate is first established with a cardinal point and cardinal coordinate system with axes along the latitude, longitude and altitude, so that the location of any object is represented by a latitude value, a longitude value, and an altitude value. In the present invention, the world coordinate element files are files that have information about objects that located within the areas corresponding the world coordinate values. For example, a world coordinate element file may be a file for an area with the range of the latitude between x to y, the longitude between a to b, and the altitude between m to n, and the content of the world coordinate element file may include the world coordinate values of all the objects within this area, and the names of the objects (that can be linked to word element files that include information of the objects), and other corresponding information of the objects (especially information specifically related to this location).

To establish the world knowledge base, currently available geographic information such as maps can be used to build the world coordinate element files directly. For more detailed information, humans, robot or robots can be used to investigate area by area to obtain locations of objects in various areas and information of the objects. The world coordinate element files can be revised with new information later obtained, and the world knowledge base can be expended from the information later obtained by robots that use the world knowledge base.

Information obtained by the robot system about the location and other information for generally unmovable objects or objects that are not often moved are saved in the world coordinate element files of the world knowledge base and the element files of the knowledge structure. For many movable objects, information other than locations will be verified to find out if there are new information so that to establish new element files or new links in the existing element files to save the unique information, otherwise, the location and other information of the object may be saved in temporary/transitional/record files, or in the world coordinate element files with temporary status, and depend on the purpose of the robot system, and the nature of the objects, the information may or may not be used when the robot systeo constructs the preliminary world view in the future.

In another embodiment of the present invention, the world knowledge base includes corresponding relationship between each point at world coordinate system with un-moveable objects and last known moveable objects (geographic information, and environmental information). In one preferred embodiment, every object is given corresponding world coordinate values in latitude, longitude, and altitude, thus for any given location, depending on the purpose of the operation, a research within a range can be set for all the objects that have corresponding world coordinate values within the set range.

Indication or specification of the objects in the world knowledge base shall be specific enough that contains sufficient identification information. The name of each object should be unique so each object name is corresponding to a specific object file in the world knowledge base. The object file in the world knowledge base may contain shape (geometric information such as length, width and depth), color, material, common name and other specific information related to specific usage. The shape, color and material information along with the exact location of the objects can be used to generate background image for environmental investigation purpose. The common name can be used to retrieve additional information of the object (such as the various meaning and attribute of the object can be used to establish links with other objects or draw inference in strategic analysis and plan stage) from the knowledge system. Information of specific usage of the object can be used by the robot system to determine whether to include this object in its plan or whether special attention will be paid to this object.

The world knowledge base may further include world coordinate base maps. The world coordinate base maps are basically path maps that will assist to create paths between two or more points in the world coordinate system. For example, road maps, sea maps and air travel maps can all be used as path maps, thus the robot system can control automobiles, ships and airplanes. The world coordinate base map may also include more detailed information so that a robot can move around an environment like a human being or even in smaller scale (such as inside the human body, navigating the blood vessels). Thus different map can be provided for different purposes, and once the purpose is determined, a corresponding map can be selected as the base of the path planning. In one preferred embodiment of the present invention, a world coordinate base map includes map element files that contains information of the critical point in the map and directions to each destinations, wherein searches can be conducted to find the nearest critical points for the robot to move according to the directions indicated by the information in the map element files. Alternatively, a visual map (similar to the ordinary map) can be established for robot systems with the visual thinking (map reading) ability, so that the robot can use the visual map to determine paths of movements.

### Action Sequence Structure

The action sequence structure comprises action sequence files and action sequence file organizing mechanism. The action sequence files generally are files that can be used to control movements of the robot body. The action sequence files may be a combination of a series of composing action sequence files (that will call for the corresponding action sequences) with a file name or identification information that represents the over all sequence. For example, an action sequence file named “running(pace, speed)” may include a series of composing action sequence file for each and every body part that will be used to perform the action of running, and the over all time sequence for calling the individual composing action sequence files. The composing action sequence file may include information regarding the movement of motors or other actuation devices such as angle, speed and duration, or in the form of electrical signal values, etc. A composing action sequence file may also call for a series of more detailed composing action sequence files that can be combined to perform the task that the composing action sequence file is to perform. The content of the basic action sequence file may contain one or more control instructions that control the movements of certain robot body components (for more than one control instructions, the time sequence of the control instructions will also be provided in the action sequence file). For example, “Finger 2, actuator 1(00213, 23, 41, 00)” may represent the control instructions that instruct the actuator 1 for the finger 2 of the robot body to move at internal time 00213 about 23 in x direction, 41 in y direction and no movement in z direction.

### Document Structure

A document structure comprises document entry files, document addresses, document contents, and a document organizing mechanism. The document structure may further comprise document summary files, wherein the document entry files provide information regarding the location of the document summary files.

The document structure can be used for organizing documents within the robot system or documents in a broader environment (such as in the World Wide Web). In one preferred embodiment of the present invention, documents are summarized to obtain key words or word phrases. The document entry files comprises key words or word phrases (as file names) and containing lists of document names having the key words or word phrases, and corresponding address information of the documents having the key words or word phrases.

In another preferred embodiment of the present invention, documents are processed by the robot system (and/or with the assistance of human operators) to be divided into categories and sub-categories, and then the documents are organized according to the categories. The document entry files have category names as file names and include lists of document names belonging to the categories, and corresponding address information of the documents belong to the categories.

In this embodiment, the document structure has more definite structure, generally in hieratic structure. By dividing documents into categories and sub-categories, the documents with similar meanings will be grouped together, thus the need for finding words with similar meaning or general meaning decreased. But the determination and division of categories can be arbitrary, although documents could be linked with different categories, there are always boarder-line instances that the documents may be mis-categorized that reduce the capacity and accuracy of the search. This method may be more useful for searches intended to locate the document, instead of searching for contents.

In another preferred embodiment of the present invention, documents are processed to obtain content word (or word phrase) lists that the documents contain. The document entry files comprises content words or word phrases (as file names) and containing lists of document names having the content words or word phrases, and corresponding address information of the documents having the content words or word phrases.

In this embodiment, document entry files will be established that each will contain the addresses of all the documents that contain the corresponding word. Generally, only words of substances will have document entry files. Thus words such as “the”, “a”, “of”, etc., etc., will not have document entry files. When searching the document structure, the document entry files will be searched by the content words as the file names. Once the document entry files are obtained according to the content words, addresses of the documents that contain the content words can be obtained, thus the contents of the documents can be retrieved according to the document addresses. The document contents are loaded to the executing system as input information, and the executing system will process the documents to assure the relevancies, and retrieves useful information from the document contents (and to organize the information and to present it to the users and/or the document address can also be presented to the users for direct access.)

The document structure using content word (or word phrase) lists may provide more access to the documents. But the search results may be numerous thus may require more processing time. In practice, the three types of methods for the document structure may coexist in the same system and the particular way to conduct the search can be selected according to the task.

The document structure is used for locating documents containing certain words, word phrases, or belonging to certain categories. The basic function of the document structure is similar to the function usually performed by a search engine, as it can provide lists and access information for documents that contain words, word phrases, or combinations of words and/or word phrases. However, the application of the system of the present invention using the document structure can expand and transcend the search function. Since the system of the present invention is able to understand the meaning of the languages, the system of the present invention can read the documents obtained by the search function of the document structure and provide relevant information and relevant documents.

### Executing System

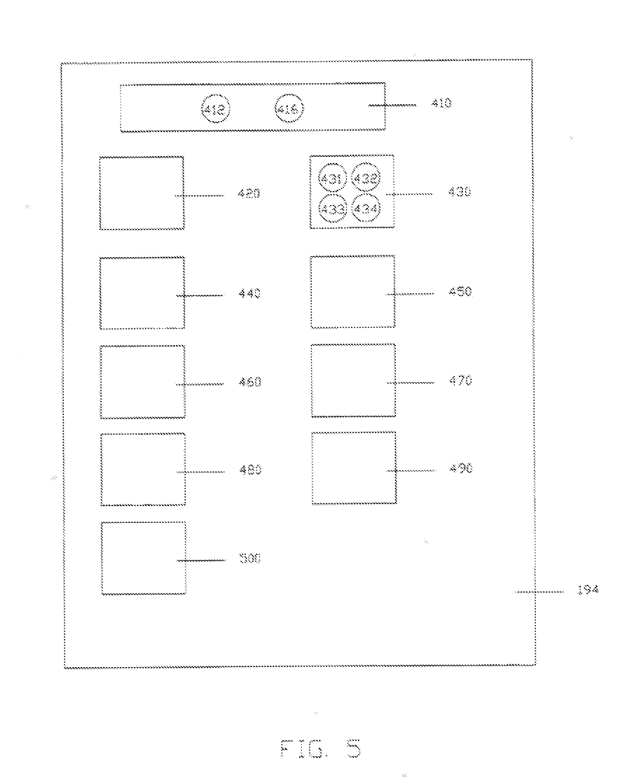

As seen in FIG. 5, the executing system 194 comprises an internal control mechanism 410, an inputting mode 420, a reading mode 430, at least one thinking mode 440, a writing mode 450 and a memorizing mode 460, an outputting mode 470, an inquiry mode 480, a verification mode 490, and a system update mode 500. The internal control mechanism 410 includes internal control rules 412 and structure rules 416. The inputting mode 420 includes inputting rules, wherein the reading mode 430 includes reading rules, wherein the thinking modes 440 include thinking rules, wherein the writing mode 450 includes writing rules, wherein the memorizing mode 460 includes memorizing rules, wherein the outputting mode 470 includes outputting rules, wherein the inquiry mode 480 includes inquiring rules, wherein the verification mode 490 includes verification rules, wherein the system update mode 500 includes system update rules. The internal control mechanism 410 can control the inputting mode 420, a reading mode 430, a thinking mode 440, a writing mode 450 and a memorizing mode 460, an outputting mode 470, an inquiry mode 480, a verification mode 490, and a system update mode 500, wherein the internal control mechanism 410 can operate constantly.

The internal control mechanism 410 includes internal control rules 412, wherein the internal control rules comprising basic rules, target rules, value rules, determinative rules, responsive rules, control rules, etc. Essentially, the internal control mechanism 410 is a decision making mechanism that decide and control the operating process of the robot system. The internal control rules in combination with the rules for each mode allow the processes of present invention to be realized. The detailed embodiment of the internal control mechanism can vary, and the internal control rules will be different for various embodiments.

The internal control mechanism shall be able to control and direct operating process of the system of the present invention in all situations. The basic idea is to provide internal operation sequence for any and all kinds of situations. The basic sequence of operation of present invention is a sequence wherein the operation process of the robot system in any and every situation will be decided. Generally, there are two kinds of operating processes, one with input, and one without input. When input information is provided, the robot will operate differently according to the type of input. If the input is a question that requires answer or a request for information, the thinking mode will provide thinking rules for solving the problems as indicated in this application. It generally requires making direct links between existing elements of the knowledge structure. If the input contains element that does not responding to any existing element file of the knowledge structure, the inquiry mode will be activated to acquire information regarding the new element. If the input is a command or command sequence that require the robot system to take actions, inquiry mode may need to be activated to acquire missing information that is required to complete the task (such as target position). The thinking mode will use thinking rules to analysis the task, and obtain relevant information. Here, the purpose of the process is to achieve certain goal, and thinking mode will be conducted to obtain links between the current condition and the goal. For example, if the task is for the robot body to move from current location to a target position, the thinking mode will first need to find the action path from the current location to the target location, and find the action sequence that will control the robot body to move from the current location to the target location on the action path. As the condition of the environment may change, the action path and action sequence for the robot body may need to change responding to the relevant changes reflected in the inputs.

If the input is informational, not a command or request, depending on the types of information, the action or reaction will be different. Ordinarily, the responsive rules will determine the input information that will trigger responses, and the type of and sequence of responding processes and actions that will be trigged. For example, a word input “fire”, or an image input of fire might trigger alarm or actions. Further, analysis of the various inputs may result in information that may trigger responsive actions. For example, if in the subsequent input images certain identified object appear to be larger and larger, it can be inferred that the object is approaching the vision sensor or sensors of the sensing and information gathering system on the robot body, and depending on the type of object, actions may be taken to avoid collision with the object.

There might be situations that input information will not trigger actional responses, but can be used to revise or add to the links in the element files of the knowledge structure, or the input information does not seem to have any apparent use at the time, so it can simply be saved in the system log, that can be used in the future. For example, an input of the location of the robot system in the world coordinate system may not have immediate use, but if later the robot system is called for to perform certain acts such as carrying some object from one place to another place, the current location of the robot system will be used in finding the action path and selecting the action sequence.

If no input is received by the robot system (or no input that will trigger any action or process is received, such as the case that image inputs is constantly received by the robot system, but no changes in the condition of the environment is found), the operating process of the robot system is only determined by the internal control rules and the internal structure of the robot system. Depending on the use and design of the robot system, the internal control rules can direct operating process such as searching for new information, or new links between existing elements using deductive process, making assumptions by conducting generalization process, inductive process, engaging in imagination process, or continuing underlining process to achieve certain specific long time or underlining goals. The sequence of activity can be determined by the internal control rules and according to the recent input and activities of the robot system. For example, the input information or information obtained as the results of inquiries for the purpose of completing particular tasks can be used to revise or establish other new links in the element files of the knowledge structure. For this purpose, the internal control rules that determine the operation process basically is a set of rules that determine which process will be given priority.

The basic rules of the internal control rules of the internal control mechanism 410 set up the basic operating process, wherein the basic rules control the basic operation such as when and how to switch from one mode to another, and setup the environment for each mode of operation. For example, a basic rule can be set that certain input will be given priority to other operations, that whenever this type of input is detected by the inputting devices, the executing system will switch to input mode, and suspend or abandon the on going process depending on the type of operation and designated by the basic rules.

The target rules of the internal control rules of the internal control mechanism 410 set up the long term targets (tasks to be completed or worked on over a long period of times) or the underline targets (on going tasks that usually have low priorities than other types of task) of the system. When no other actions will be taken by the executing system, the executing system will operate according to the target rules. For example, the target rules may designate that the robot system may conduct activities such as searching the document structure for new words or word phrases and learn the meanings of them; and processing information in the knowledge structure and to make assumptions, by generalization, or induction and then try to verify the new assumptions, wherein the target rules may provide information as to when the executing system will try to learn new words, and when the executing system will make new assumptions. Also, the target rules may also direct the executing system to act to achieve some underlining goals that are input task requests that has low priorities and will require substantial processing time. For example, there might be a task input for finding all the documents in the document structure that contain the word phrase “Los Angeles”, wherein the task has low priority, and the task cannot be completed (as new documents that contain the word phrase “Los Angeles” may be added to the document structure). The task can be converted to underlining target (or task) that the target rules may direct the executing system to act on when no other actions are required of the executing system. Generally speaking, the target rules tell the executing system what to do when no other actions are required.

The value rules of the internal control rules of the internal control mechanism 410 may provide positive values or prohibitive values for actions (usually in reference to results that can be obtained by the actions). For example, in one preferred embodiment of the present invention, each action sequence can be evaluated according to the goals can achieved and negative results from the action, and assign corresponding value to the action sequence. The value for the action sequence would not be realized unless the conditions for achieving the goal or bringing out the negative results are met. Thus, the value rules provide values for action sequences when the conditions for realizing these values are met.

The value rules of the internal control rules of the internal control mechanism 410 may also provide probability values for assumption or prediction processes. For example, the robot system may be ask to predict the temperatures for the future, and different methods and information can be used for making the prediction. If statistically, using the method of calculations based on climate models and sample data are more accurate than simply obtain the average temperature based on the historic data, the process based on climate models will be given a higher probability value, with given condition that certain kinds of sample data are used. Thus, in this case, the value rules provide values for assumption or prediction processes when the conditions for realizing these values are met.

The determinative rules of the internal control rules of the internal control mechanism 410 set up rules as to determine what decisions to make. For example, when different inputs that require different actions that are either in conflict or too numerous, the determinative rules enable the executing system to decide what actions to take and what actions to eliminate. As an example, when the image inputs indicate that there is a rock like object fast approaching the robot body, and there is also a sound input for the robot to move some objects, the determinative rules may allow the executing system to temporary suspend performing the acts of moving some objects, and first move to avoid being hit by the rock.

The determinative rules can also decide what conclusion to draw in the thinking process that involves assumptions or predictions. For example, when the executing system of the robot system direct the robot body to move to another location when an object is moving towards the robot body, the thinking mode of the executing system may operating under the thinking rules that make the assumption that the moving object is not going to stop before the object hits the robot body and the collision of the moving object will either harm the moving object (assuming the result is undesirable) or the robot body, and will try to move to avoid being hit. But, if the executing system of the robot system decided that the moving object is a human being (or another robot body) that moves consciously and makes the assumption that the moving object will stop before collide with the robot body, the executing system of the robot system may direct the robot body to continue the movement to complete the task according to the determinative rules.

The determinative rules direct the executing system to make decisions with reference to other rules such as value rules. As value rules provide values for actions or assumptions or predictions, the determinative rules will use the values provided to evaluate and select actions, assumptions or predictions. Generally speaking, the determinative rules simply select the actions that have the higher positive values or over all values (positive values minus prohibitive values) in cases when selections need to be made, and select the assumptions or predictions that have the higher probability values. However, there might be situations that different types of value rules are used, and values provided by the value rules cannot be directly compared, then the determinative rules will be to set priorities for various types of value rules.

The responsive rules of the internal control rules of the internal control mechanism 410 set up rules as to when and how the system will respond to external conditions. For example, the responsive rules may direct the executing system of the robot system to move the robot body to another location when the image inputs indicate that an object is moving directly towards the robot body and the object would not stop to avoid collision.

The control rules of the internal control rules of the internal control mechanism 410 set up rules that relate to control mechanisms, such as selecting and using action sequence files. For example, the control rules may decide what action sequence files to use, how to combine the action sequence files and set the parameters for the action sequence files. The control rules may also call for close monitoring of certain input signals that related to feedback of the actions, and to revise the action sequence accordingly.

In general, the internal control rules are files that contain commands that will be triggered by corresponding conditions. In any given time, and in any given point of the process of the executing system the robot system is in certain condition, and the information that relates to the condition will often trigger internal control rules to direct the executing system to conduct the subsequent processes. The internal control rules can be in various formats, and what is essential is that inputs or internal conditions of the robot system should be able to direct the executing system to process accordingly as directed by the internal control rules. Basically, the basic rules set up the basic framework of the process of the executing system, wherein the basic rules will direct the executing system to operate in various mode according to the current inputs or system conditions, and call upon various rules such as target rules, value rules, determinative rules, responding rules, and control rules etc. to determine as to what processes should be conducted.

In one preferred embodiment of the present invention, an internal control rule organizing mechanism will organize the internal control rules according to internal control rule file names, wherein the internal control rule file names having alphabets, numbers or symbols that can be recognized by the internal control rule organizing mechanism and thus the internal control rule organizing mechanism will be able to provide access to the internal control rules according to the internal control rule file names. The contents of the internal control rule files will contain links between words, values, and other conditions with rules that control the action of the executing system of the robot system. For example, an responding rule file may be named “Avoid-collision( )”, wherein the content of the file “Avoid-collision( )” may include commands such as “If moving-value(object)>0, and intersect(moving-direction(object), robot position)=0, then call(moving-to-safe-location( ))”.

In one preferred embodiment of the present invention, the structure rules comprise basic sentence rules, sentence construction rules, sentence dissection rules, specific rules that correspond to specific function words or word phrases, etc. Generally speaking, the structure rules combined with information in the word element files provide ways for sentence construction and dissection that will follow the grammar rules of the respective language. By using the structure rules combined with information in the word element files, links can be established based on information input in sentence format, and link information can be output or written in sentences.

The inputting rules, the reading rules, the thinking rules, the writing rules, the memorizing rules, the outputting rules, the inquiring rules, the verification rules, and the system update rules all comprise rules that will direct the corresponding processes of the inputting mode, the reading mode, the thinking mode, the writing mode, the memorizing mode, the outputting mode, the inquiring mode, the verification mode, and the system update mode. Similar to the internal control rules, they are files that contain commands that will be triggered by corresponding conditions.

For example, the inputting rules of the executing system comprise input image processing rules that will process the image inputs using image process tools such as filtering, so that the image inputs can be processed further in the reading mode. The inputting rules may also comprise rules that identify the types of inputs and send the information to the executing system so that the executing system can respond to the type of inputs according to the basic rules.

If the internal control mechanism 410 detects input information from the inputting devices of the sensing and information gathering system, the inputting mode 420 will be activated according to the internal control rules. According to the inputting rules, the inputting mode 420 takes input information from inputting devices of the sensing and information gathering system, such as key board, microphone, internet site, digital camera, scanner, and other inputting devices and converts the input information into format that can be readable by the executing system 194.

If the input is from a digital camera, a digital camera recorder, or other image sensing device, the input will first be identified as image input and processed using the image processing tools (which will first extract informational image from the image input) according to the inputting rules. To extract informational image from the input image, various image processing tools can be used. For example, using a noise filter, the noise in the input image can be reduced. Other image processing technique can also be used. For example, color image can be turned into gray scale image, and pixel values with gradual increases can be normalized or replaced with a uniformed single value, so that outline sketches of the objects in the input image can be obtained.

The sensing and information gathering system of the present invention may further include one or more scanning laser range sensors, or laser scanners, or radar scanners. The scanning laser range sensor, or laser scanner includes a laser rangefinder extracts 3D information from the objects. The 3D information is provided as a set of data points. A radar scanner can quickly detect moving objects that would be very useful when the robot is controlling moving objects such as automobiles, ships or airplanes. The input signals from these sensing devices are also be identified and processed according to the inputting rules. The information from input signals of these sensing devices are often used to supplement information obtained from the image inputs.

The reading mode 430 processes information received from inputting devices and converted by inputting mode 420. Preferably, the reading mode 430 comprise word processing 431, image processing 432, sound processing 433, and other information processing 434. For word processing 431, one default language can be set, and can be overwritten by inputting information. For word processing 431, the information preferably will be divided into sentences by specified sentence dividing mark, or symbolized either by combination of period (or question mark, exclamation point, etc.), space and capital letter, or by other symbols. In reading the sentences, each word in the sentences will be identified by searching and locating the corresponding element file of each word or phrase in the knowledge structure according to the file organizing mechanism, then the element files will be loaded to a temporary location easily accessible by the executing system 194.

For image input, the informational image obtained by the inputting mode will be further processed by the image process tools according to the reading rules to identify a plurality of basic image components in the informational image. To identify basic image components from the informational image, many pattern matching methods can be used to compare the informational image with sample images of the image element files for various image elements in the image library of the knowledge structure. Special features in the informational image can be used to provide guidance for searching image element files in the image library that may match image components in the informational image.

In one example, colors can be reference as to the types of objects or environments that informational image represents. For example, greenish irregular image components may be images for grass, plants, or trees, and blue/gray areas may represent sky or ocean.

Many pattern-matching methods use assumptions or threshold values. Thus background information (information related to the possible contents of the image input from prior knowledge, circumstances related to the image input or information accompanies the image input that is used to explain the image input) can be used in this step of process. For example, in the background information indicated this image may contain image of people, facial components will be assumed. In the process, assumptions or threshold values will be set to allow face component identification more possible. A fractal image may also be interpreted more towards these possibilities.

In one example, the lines in the informational image are first processed to obtain the corresponding contour values for the lines. The contour values of the lines will be used to obtain corresponding sample images of the image element file in the image library. The contour value for the line can be calculated by using the perimeter, covered area, minimum, average and maximum curve value of the line, the location of the minimum, maximum curve value, etc. The sample images then can be adjusted to the scales of the basic image components of the informational image and be compared with each other by subtracting and average the pixels.

In one embodiment of the present invention, each of the informational images are processed according to the following steps:

in step a, the informational image is divided into single line components;
in step b, the single line components are processed to obtain single line component centers;
in step c, for each single line component, the radial distance between each point of the single line component and the single line component center is obtained respectively;
in step d, for each single line component, the shortest radial distance between the single line component center and the single line component is determined respectively, and the value of radial distance between each point of the single line component and the single line component center in respect to the shortest radial distance between the single line component center and the single line component is obtained respectively.

Alternatively, other value such as average radial distance can be used as the base for calculating the relative value of the radial distance between each point of the single line component and the single line component center. For pattern matching, it is the relative value of the radial distance between each point of the single line component and the single line component center, not the absolute value that are important.

In another preferred embodiment of the present invention, according to the features of the informational image, the reading rules of the executing system select predetermined groups of basic image element files from the image library and use the selected basic image element files to conduct pattern matching with the informational images. Image components that match with the selected basic image element files will be identified, thus the informational images will be divided into identifiable basic image components.

The first link information, the second link information, the third link information (and so on) and the word association information of the image element files that corresponds to the basic image components can provide further information for selecting compositional image element files (composed of images of the basic image element files) that might match with portions of the informational image. When matches are found between the compositional image element files and portions of the informational image, more information is obtained from the informational image. The process can be continued until all objects represented in the informational image are identified.

The identified component images can be saved in the corresponding compositional image element files of the image library as reference sample images, which can be verified by humans and then to be saved as sample images.

For word input, in thinking mode, the executing system 194 will read information from identification files of the element files and find out whether the word is a noun, a verb, a pronoun, etc. The executing system 194 contains standard sentence formats in the structure rules that can be compared with input sentences. By comparing the sentence format, the input sentences can be divided into three types, a statement, a command or a question. A statement basically provides new information to establish new links. A command demands action. A question usually presents a problem that needs to be solved. For a sentence that is a statement, the executing system 194 will further identify the sentence format to determine what link the sentence is creating.

A sentence usually contains subject and predicate. In general, there are about five basic sentence structures. The subjects of the sentences are similar, consisting only of a noun and an article or marker. But each predicate is different because the relation between the verb and the remaining words is different. In the first sentence structure, the predicate consists only of the verb, which is called intransitive verb. This type of sentence usually indicates the actions the entity presented by the noun takes. At least in mostly cases, reading the element file for the verb, especially the fourth identification value 2114, the type of the sentence structure can be determined. The fifth identification value 2115 can be used to verify the sentence structure. Then the third link information file 2123 will provide more detailed and specific sentence structures related to the verb, including any indication of conditions such as where, when, why, who and how. Comparing the input sentence with the specific sentence structure, any missing parts can trigger inquiry mode 480 to request missing information. If no information is missing, from information from the first link information file 2121, the second link information file 2122, the fourth link information file 2124 and the fifth link information file 2125, other information can be obtained as the causes of the action or the results of the action indicated in the input sentence, thus new links can be created such as new conditions and occurrences related to the subject or new subjects.

In the second sentence structure, the predicate consists of a verb followed by a noun. The noun completes the meaning of the verb by identifying who or what receives the action of the verb. This noun is a direct object. Verbs that require direct objects to complete their meaning are called transitive. This type of sentences usually indicates the changes of the noun in the object because of the action took by the noun in the subject. Reading the element file for the verb, especially the fourth identification value 2114, the type of the sentence structure can be confirmed. The fifth identification value 2115 can be used to verify the sentence structure. Then the third link information file 2123 will provide more detailed and specific sentence structures related to the verb, including any indication of conditions such as where, when, why, who and how. Comparing the input sentence with the specific sentence structure, any missing parts can trigger inquiry mode 480 to request missing information. If no information is missing, from information from the first link information file 2121, the second link information file 2122, the fourth link information file 2124 and the fifth link information file 2125, other information can be obtained as the causes of the action or the results of the action indicated in the input sentence, thus new links can be created such as new conditions and occurrences related to the subject, object or new subjects, or new objects.

In the third sentence structure, the predicate also consists of a verb followed by a single noun. But here the verb serves merely to introduce a word that renames or describes the subject. The noun following the verb in this kind of sentence is a subject complement, or a predicate noun. Verbs in this pattern are called linking verbs because they link their subjects to the description that follows. The subject complements in this sentence pattern may also be adjectives. Adjectives serving as complements are often called predicate adjectives. By reading the element file for the verb, especially the fourth identification value 2114, the type of the sentence structure can be determined. The fifth identification value 2115 can be used to verify the sentence structure. Then the third link information file 2123 will provide more detailed and specific sentence structures related to the verb, including any indication of conditions such as where, when, why, who and how. Comparing the input sentence with the specific sentence structure, any missing parts can trigger inquiry mode 480 to request missing information. This type of sentences usually establishes the links between the two nouns in the sentences, the noun as subject complement is more general than the noun as the subject. In this case, the first link information file 2121, and the second link information file 2122, or sometime the third link information file 2123 of the two nouns can be updated. The adjectives usually provide values for the attributes of the nouns. In this case, the sixth link information file 2126 or eighth link information file 2128 of the noun may be updated adding the adjective to the attribute value.

In the fourth sentence structure, the predicate consists of a verb followed by two nouns. The second noun is a direct object, the first noun is an indirect object, identifying to or from whom or what the action of the verb is performed. This type of sentences usually means the exchange of an item, information from the noun of the subjective to the noun of the indirect object. By reading the element file for the verb, especially the fourth identification valve 2114, the type of the sentence structure can be verified. The fifth identification value 2115 can also be used to confirm the sentence structure. Then the third link information file 2123 will provide more detailed and specific sentence structures related to the verb, including any indication of conditions such as where, when, why, who and how. Comparing the input sentence with the specific sentence structure, any missing parts can trigger inquiry mode 480 to request missing information.

The information in this sentence can be used either to update the sixth link information file 2126 for noun of the subjective and the noun of the indirect object, or to obtain information such as the causes of the actions or the result of the action from the fourth link information file 2124 and the fifth link information file 2125 of the verb with the help of information from the first link information file 2121, the second link information file 2122 of the nouns and verbs.

In the fifth sentence structure, the predict also consists of a verb followed by two nouns. But in this pattern the first noun is a direct object and the second noun (object complement) renames or describes it. This type of sentences usually means that the noun as the direct object has direct link with the noun as object complement. Usually the noun as object complement is more general than the noun as the direct object. The complicity of this type of sentences is that it also indicates the noun in the subject is the cause or reason that the link between the direct object and the object complement exists. This might make the link more contingent, therefore the link more likely become conditional link.

The information obtained from the thinking mode will be saved in a temporary status by memorizing mode 460, and then the executing system 194 will read the next sentence. If the thinking system is given a problem to solve, or a task to perform, one or more sentences could be command or question sentence. The command or question sentence can be detected in a few ways. For example, if a sentence starts with the word “do”, “is”, “have”, etc., or interrogative pronouns, and ends with a question mark, then the sentence is a question sentences. If a sentence starts will a verb without a subject in front, then the sentence could be a command sentence. The tasks can also be inputted by specified ways that can trigger the required act by the internal control mechanism 410 of the executing system 194.

Sentences could have other words or phrases that usually indicate where, when, why, who and how. Compound sentences are more than one basic sentences usually marked by conjunctions. The thinking mode 440 should be able to detect the words that indicating the functions and sentence structures according to the information in the element files.

In reading sentences, tracking the relationship between pronouns and related nouns could be accomplished by trial and error. A pronoun replaces a noun that appears prior to the pronoun. When more than one nouns appears before the pronoun that can be replaced by the pronoun, these nouns can be placed in the position of the pronoun in the sentence. Usually the meaning of the nouns will indicate which one is in right place in cooperation with the sentence. If uncertainty arises, the internal control mechanism can either enact inquiry mode 480, or provide alternative output based on different assumptions.

The common questions and tasks include the quests for values, verifications, etc. First, the sentence will be read as for the statement sentence, identify each word, searching, locating element file of each word, and determine whether the word is a noun, verb, pronoun, etc. The basic approach for solving a problem is to first identify what is the critical word or words according to the sentence structure, i.e., what the question or task calls for, then read the element file of the critical words, through links in the element file to find other words related to the critical words. Each word will be compared with the words in the element files in the temporary elevated status (element files in the knowledge structure related to input information that are loaded to areas easily accessible by the executing system), until a match occurs. If no match was found, the executing system will locate the element files of the words related to the critical words and search the contents of the these element files to find more related words to the critical words. Meanwhile the executing system will locate and elevate element files of the words that are in the contents of the element files that is in the temporary elevated status, to the temporary elevated status as well, and then the words related to the critical words will be compared to the contents of the newly elevated element files, to find a match. The process can be continue until all related element files have been compared and a match is found, or controlled by external interruption or internal control. If no match can be found, the executing system 194 will make inquires about missing link. This process basically traces the links of the critical words and the given words, until there is a cross point where link can be established.

When thinking mode 440 is put into action by internal control mechanism 410 according to the internal control rules, not triggered by input information, the thinking mode 440 can make new direct links between existing elements according to the information in the existing element files, or make new link process files according to the existing link process files and information in the existing element files. According to the internal control rules, the internal control mechanism 410 can also try to make assumptions such as providing hypothetical tasks imitating the real life tasks and try to complete the tasks so that to obtain new direct links and new link process files.

The information obtained can first be expressed in sentences by the writing mode 450. For an answer to a question, the word directly links to the critical word usually replace the critical word in the question sentence, and the sentence is transformed into a statement sentence. For different task, the way of writing may be different, it is basically placing relevant words in sentence formats determined by the executing system 194 according to the structure rules.

The sentences from writing mode can be delivered to output device by outputting mode 470, wherein they can be displayed to the user or control some devices.

For image inputs, thinking process using words association can be used to identify or verify objects with complex images and/or unidentifiable portions in the informational images. For example, in an image input that the robot system has background knowledge that the image is from an outdoor environment, when buildings are identified from the image (specially with the helps of the laser scanners), the executing system can use word association to conclude that the image input is about a city scene with streets, and an unidentified object (because of the difficulty of lack of simple image components in the image portion) on the street can be assumed to be a vehicle (according to approximate size and location of this object). This assumption can be further verified if the object moves in various image inputs (as vehicles will move on the streets).

The process in thinking mode relating to image inputs can be called “visual thinking”, as the components from image inputs can be involved in the thinking process directly. The most strictly “visual thinking” process (process that does not directly involved with word association) can be exemplified in the process that identifies whether an object is moving. In a simple situation, a ball flying in the open field towards the image input devices of the robot system can be easily identified by comparing the image inputs obtained earlier with the image inputs obtained later, when the thinking rules include a rule that an image component in subsequent image input (in designated time segments) that has similar shape but bigger size can be assumed to be the image component of the same object as in the prior image input, wherein the distance between the object and the image inputting device of the robot system is shorter in the subsequent image input. More rules and calculating tools can be used to determine the moving direction of the object and so on.

If no expressed task has been given, the input information can be evaluated to determine if any action, reaction or other system operation need to be taken, based on the internal control rules of the internal control mechanism. For example, input image of one time segment can be compared with the input image of the previous time segment, and if one object in the later time segment is bigger than in the previous time segment, then the system may trace the object to determine if the object is approaching the robot, and if it is determined to be the case, the robot may take actions according to the responsive rules of the internal control mechanism.

If the input is a word command that requires actions, the executing system first will need to obtain environmental condition from the input, or system status information, then the executing system will need to obtain target information and make plans to carry out the action. For example, if the robot system controls a car, and the task is to go to certain place, then the executing system of the robot system will need to obtain world coordinate location of the place, the world coordinate map, and determine the action path as how to get there, and be on alert as to avoid collisions on the way there. If the task is for a robot system to carry certain object to certain final location, then the robot will need to first locate the object, go to the location of the object, pick up the object, and go to the final location.

In a preferred embodiment of the present invention, once the success links are established, the routes for making the link are identified and saved by the memorizing mode 460. This information can be saved in a preferred process file of the process file structure, wherein the element files of the given words and critical words, and important link words will contain information referring to this process file. The process file can be identified by the given words, critical words, and/or important link words.

The preferred process file can be generalized and expended to provide more link route by thinking mode 440. When the process file structure is established, the problem solving process may start with search the process file structure for process file that matches the given words and critical words of the problem. This will save time and effort.

In a preferred embodiment, the entire process of the executing system may be document and identified by contents and time of execution by memorizing mode 460, and can be used for verification, generalization, and expansion of the process file, and any other purposes.

The outputting mode of the internal control mechanism controls output devices to write word output to display devices, to output sound output to speakers, or to control actuation system to actuate robot body. When controlling the actuation system, the output rules may refer to control rules to plan action sequence of the corresponding components of the robot body, wherein at least one action sequence file will be selected from an action sequence structure according to the characteristics and/or corresponding relationships between the significant goal positions and the significant current positions of the corresponding components of the robot body, wherein the more than one action sequence files can be selected to jointly perform the task.

Subsequently, the internal control mechanism can run the verification mode 490, that will direct the executing system through the inputting mode, the reading mode, and the thinking mode to verifying the actual significant goal positions with the targeted significant goal positions, wherein if the actual significant goal positions are different from the targeted significant goal positions, the output mode will provide correcting action sequence to complete the task.

The inquiry mode 480 inquiry information either from document structure, outside sources, or human operators. Technically, the document structure does not need to be part of the robot system, but the operation of the document structure must be compatible with the robot system. When information is requested and inquiry mode is called for, the information in the document structure can be first searched, if no answer is found, the inquiry rules will decide whether to request information from other sources or the human operators. But sometimes it is obvious that the information cannot be found in the document structure, thus the inquiry rules will first determine where to request the information from.

When the inquiry rules lead to the document structure to search for the information, the process is basically a search process, therefore the inquiry rules will include searching rules. Depending on the types of document structures, the searching rules might be a little different.

When the system of the present invention is used for document search purpose, there is difference between the system of the present invention and the ordinary “search engines”. As the system of the present invention can “think”, and “understand” the meaning of the language, the inputs for the purpose of conducting document searches could be different from the ordinary searches. When using the system of the present invention, the inputs can be is conversation style, or any other style, and the key is to be specific.

In fact, the ordinary uses of the search engines often have two different purposes, one is for finding information, and another is for finding a particular document or type of documents. For the first purpose, there might not be a need for conducting the document search in the document structure, because the system might be able to find the information from the knowledge structure (and/or world knowledge base) by using thinking mode, thus the process will simply be a problem solving, or question-answer process. Only when no answer can be found in the knowledge structure, the inquiry mode will need to be operated to conduct the search in the document structure. Before the inquiry mode is called for, the system of the present invention will go through the inputting mode, the reading mode, the thinking mode, and the input information will be analyzed. Thus information (links) in the element files for words in the question along with the words in the question will be used to conduct searches in the document structure. For example, the searches in the document structure are done by search the document entry files that the category words are the file names. Once the document entry files are obtained according to the category words, addresses of the documents that correspond to the category words can be obtained, thus the contents of the documents can be retrieved according to the document addresses. The document contents obtained from the document structure will be processed by the system of the present invention by going through reading mode, thinking mode, wherein information required to answer the question inputted by the user will be analyzed, organized (and verified if more than one document sources are available), and presented in a proper form. Such saving the user time and effort, and provide better results.

For example, in the embodiment where the document entry file names are key words, the input information will be processed by reading mode and thinking mode, and from the knowledge structure of the present invention, words of similar meanings and words of more general meanings of the words in inputs can be obtained. Thus, the documents that contain key words that are with similar meanings, or more general meanings (or more specific meanings) can all be found by the key word searches conducted by the executing system with the helps of the document organizing mechanism. For example, a document on a website may contain information about oranges that contain high Vitamin C substance. Thus the key words for this website may include oranges, Vitamin C, etc. If the user is making an inquire about the nutrition values of fruits, or how to eat healthy, the method of search of the present invention may be able to find the website and provide related information to the user even if this website does not contain the words “fruit”, “food”, “nutrition values” and “healthy”, because the key words searches can be expanded to include “oranges”, “Vitamin C”, etc.

For the second purpose (to find a document that is located in the document structure), the system of the present invention will still go through inputting mode, reading mode, thinking mode, before inquiry mode is called for, and the input will be analyzed before the inquiry mode. As the system of the present invention is able to understand to meaning of the request, the user can specify in detail the type of documents that he or she is searching for, and the system of the present invention will use this information not only in searching for the documents, but also in reviewing the documents to the specific document (or documents) that meets the request. For example, in the embodiment where the document structure is organized by categories and subcategories, the system of the present invention can use reading mode and thinking mode to process the user request to obtain the information regarding the categories and subcategories that the documents that meet the request may belong to, and use the inquiry mode to search the categories and subcategories of the document structure, and process the documents obtained by the search in reading mode and thinking mode, until one or more specific match is found. If no match is found, the search can be expended for words with similar or more general (or specific) meaning of the related words. The expansion of word categories can continue with all links with the related words until the specific document (or documents) is found.

In a preferred embodiment, the new link information obtained from generalizations or inductions by thinking mode 440 memorizing mode 460 can be verified by verification mode 490, and to be used to update the related element files.

In a preferred embodiment, the operating process of the executing system 194 can be saved according to operating time of the executing system 194 and related element files and link process files to system log files in the system log. The system log files can be used for many purposes. They will be especially useful when certain direct links in certain element files need to be revised, for the system log files can provide the records of changes to other element files or link process files in the past based on those direct link information and revise other element files or link process files.

The verifying, generalizing, expending capabilities are part of the special features of the system of the present invention, whereby the system of the present invention is more self-sufficient, self-learning, progressive. Combined with feature of inquires, and self-controlled operating capacities, the present invention will be able to expand the knowledge structure, process structure with little exterior assistance once the basic structures are established. Because the system of the present invention not only can read and understand input information and perform related task, it can also learn and improve itself, it is truly intelligent.

Because some links between elements are conditional, or only possible links, the thinking mode can provide alternative links or possible links between relevant elements. Therefore the output of the thinking process can be alternative or possible links. The conditions for the alternative output will be provided, and the degree of possibility can also be reflected in the element files and the output information.

In one preferred embodiment, the present invention may contains multiple knowledge structures that can be multiplied and revised, wherein one basic multiple knowledge structure contains links that are general, and other multiple knowledge structures are modified to reflect specific environments these knowledge structures represent. This arrangement makes sense because the human knowledge system is highly subjective. In one person's opinion the link may be true, but another person may think no link existed. Having separated knowledge structure may limit the information to the most accurate condition, while using the available information to the full extent.

### CONCLUSION

The teaching of this invention includes that the human knowledge system should be indicated as a knowledge structure where elements in the structure have multiple links with other elements. The way of expressing the links should not be limited to what is described in this application. Other links can be used as well.

What is claimed is:

1. A method for operating a human-made system, including one or more CPU's, one or more I/O devices, and one or more memories, comprising the steps of:
(a) establishing a knowledge structure including a language file organizing mechanism, and more than one language element files, wherein the language element files include identifying information and knowledge information;
(b) establishing a process structure comprising a process file organizing mechanism, and at least one process file;
(c) establishing a world knowledge base; and
(d) establishing an action sequence structure.

2. A method as claimed in claim 1, wherein the knowledge structure further comprises an image library, a sound library, a touch and sense library.

3. A method as claimed in claim 2, wherein the image library further comprises an image element file organizing mechanism and at least one image element file, wherein the sound library further comprises a sound element file organizing mechanism and at least one image element file, wherein the touch and sense library further comprises a touch and sense element file organizing mechanism and at least one touch and sense element file.

4. A method as claimed in claim 3, further comprises the steps of:
(e) establishing a document structure comprising document entry files, document addresses, and document contents, and a document organizing mechanism;
(f) establishing an executing system comprising an internal control mechanism and an inputting mode, a reading mode, a thinking mode, a writing mode, a memorizing mode, an outputting mode, an inquiry mode, verification mode, and a system update mode;
(g) wherein the internal control mechanism further comprises internal control rules and structure rules, wherein the internal control rules include basic rules, target rules, value rules, determinative rules, responsive rules, and control rules; and
(h) establishing a system log.

5. A method as claimed in claim 4, further comprises the steps of:
(i) running the executing system wherein the internal control mechanism can operate constantly, wherein the thinking mode, inquiry mode, memorizing mode, verification mode, and a system update mode can be activated according to the internal control rules of the internal control mechanism not triggered by an input;
(j) if input information is to be received from an inputting device of a sensing and information gathering system, the internal control mechanism will operate inputting mode according to the internal control rules, wherein the input information will be converted to format conformed with the format requirement by the executing system according to the inputting rules, wherein information other than language may be converted to language information, or information other than language may be pre-processed by the information processing tools to prepare for further processing in the reading mode;
(k) once input information is received by the executing system, the internal control mechanism will activate reading mode according to the internal control rules, wherein according to the reading rules, the input will be disseminated into elements and element files of the knowledge structure with corresponding elements matched with the input elements will be located and loaded into the executing system (or areas easily accessible by executing system) according to the file organizing mechanism of the knowledge structure;
(l) if it is determined a specific task is called for, the internal control mechanism will activate the thinking mode, wherein according to the thinking rules designated by the internal control mechanism, the thinking mode can establish new direct links between the existing elements of the knowledge structure that match with the elements of the input information according to the input information;
(m) wherein the new direct link between the first existing element and the second existing element can be saved to the element file of the first existing element and the element file of the second existing element by the memorizing mode according to the memorizing rule, wherein the linking process for linking the first existing element with the second existing element can be saved as a process file to a process structure by the memorizing mode according to the memorizing rule, wherein information including the new direct link between the first existing element and the second existing element can be written to a display device by the writing mode according to the writing rules and the structure rules of the internal control mechanism, wherein the new direct link between the first existing element and the second existing element can be converted to information other than language and outputted as control signal to output device by the outputting mode according to the outputting rule;
(o) wherein the internal control mechanism can operate inquiry mode according to the internal control rules, wherein the inquiries can be sent to display device or output device to inquire information, or document structure, wherein the input information responding to the inquiries will be processed by inputting mode, reading mode, and thinking mode, and memorizing mode to establish new direct links between the existing elements, new direct links between new elements and existing elements of the knowledge structure, and new element files; and
(p) if new links and/or new element files and/or new process files are established, the internal control mechanism can operate the verification mode to verify new direct links and the new linking processes; the internal control mechanism can also operate the system update mode to update the internal control rules, the structure rules, and the process files in the process structure, wherein the system operator's participations are often needed.

6. A human-made system including one or more CPU's, one or more I/O devices, and one or more memories, comprising a knowledge structure, a process structure, a knowledge base, a document structure, an executing system, and a system log.

7. A system as claimed in claim 6, further comprising an action sequence structure, and an actuation system.

8. A system as claimed in claim 7, wherein the knowledge structure further comprises an image library, a sound library, a touch and sense library.

9. A system as claimed in claim 8, wherein the image library further comprises an image element file organizing mechanism and at least one image element file, wherein the sound library further comprises a sound element file organizing mechanism and at least one image element file, wherein the touch and sense library further comprises a touch and sense element file organizing mechanism and at least one touch and sense element file.

10. A system as claimed in claim 9, wherein the image element file further comprises an image information file, an identification file and a link file.

11. A system as claimed in claim 10, wherein the sound element file further comprises a sound information file, an identification file and a link file.

12. A system as claimed in claim 11, wherein the touch and sense element file further comprises a touch and sense information file, an identification file and a link file, wherein the touch and sense information file can include information indicated by other touch and sense element files.

13. A system as claimed in claim 12, wherein the world knowledge base further comprises world coordinate element files and world coordinate element file organizing mechanism.

14. A system as claimed in claim 13, wherein the action sequence structure further comprises action sequence files and action sequence file organizing mechanism.

15. A system as claimed in claim 14, wherein the action sequence file further comprises information indicated by other action sequence files.

16. A system as claimed in claim 15, wherein the world knowledge base further comprises object files.

17. A system as claimed in claim 16, wherein the world knowledge base further comprises world coordinate base maps.

18. A system as claimed in claim 17, wherein the world coordinate element file includes world coordinate values of objects.

19. A system as claimed in claim 18, wherein the world knowledge base includes corresponding relationship between each point at world coordinate system with un-movable objects and last known movable objects.

20. A robot system including one or more CPU's, one or more I/O devices, and one or more memories, comprising: a body, a sensing and information gathering system, an information inquiry system, an information output system, a knowledge structure, a process structure, a world knowledge base, an action sequence structure, a document structure, an executing system, a system log, and an actuation system.
